(19) United States
(12) Patent Application Publication
(10) Pub. No.: US 2013/0236416 A1
(43) Pub. Date: Sep. 12, 2013

(54) SURFACE MODIFIED COLLOIDAL PARTICLES

(71) Applicant: CLEMSON UNIVERSITY, Clemson, SC (US)

(72) Inventors: Parul Rungta, West Palm Beach, FL (US); Michael Daniele, JR., Central, SC (US); Stephen H. Foulger, Clemson, SC (US); Ragini Jetty, Clamson, SC (US)

(73) Assignee: Clemson University, Clemson, SC (US)

(21) Appl. No.: 13/788,568

(22) Filed: Mar. 7, 2013

Related U.S. Application Data
(60) Provisional application No. 61/607,660, filed on Mar. 7, 2012.

(51) Int. Cl. C08F 138/00

(52) U.S. Cl. CPC C08F 138/00
USPC 424/78.27; 435/180; 435/189; 525/328.1

(57) ABSTRACT

The present invention generally relates to surface modified colloidal particles. The invention further relates to methods of preparing and methods of using the same.

### RELATED APPLICATION DATA

This application claims the benefit of U.S. Provisional Patent Application Ser. No. 61/607,660, filed Mar. 7, 2012, the disclosure of which is incorporated herein by reference in its entirety

### STATEMENT OF GOVERNMENT SUPPORT

This invention was made with government support under Defense Advanced Research Projects Agency (DARPA) Grant No. N66001-04-1-8933. The United States government has certain rights to this invention.

### FIELD OF THE INVENTION

The present invention generally relates to surface modified colloidal particles. The invention further relates to methods of preparing and methods of using the same.

### BACKGROUND

Colloidal particles can be used for a wide variety of applications. However, there remains a need for colloidal particles that can easily be functionalized with different substrates using methods that can be fast, efficient and able to be scaled up for industrial preparations. In addition, there remains a need for colloidal particles that can incorporate an array of functionalities.

The present invention addresses previous shortcomings in the art by providing surface modified colloidal particles and methods of preparing and methods of using the same.

### BRIEF SUMMARY OF THE INVENTION

A first aspect of the present invention comprises a method of producing a substrate modified colloidal particle comprising, providing a suspension of colloidal particles in an aqueous solution; adding a substrate to the suspension; and attaching the substrate to the colloidal particle using a click chemistry reaction.

A second aspect of the present invention comprises a colloidal particle comprising a polymer core and a substrate attached to an outer surface of the polymer core, wherein upon contact with a target molecule having an affinity for the substrate, the colloidal particle immobilizes the target molecule and subsequently releases the target molecule without affecting the target molecule's bioactivity.

A further aspect of the present invention comprises a method for isolating a target molecule from a mixture comprising: providing a colloidal particle comprising a polymer core and a substrate attached to an outer surface of the polymer core, wherein the substrate has an affinity for a target molecule; adding the colloidal particle to a mixture comprising the target molecule; incubating the colloidal particle with the mixture for a period of time; and removing the colloidal particle from the mixture, thereby isolating the target molecule from the mixture.

Another aspect of the present invention comprises a colloidal particle comprising a polymer core and a fluorescent substrate attached to an outer surface of the polymer core, wherein the emission and/or intensity of the fluorescent substrate is increased compared to the emission and/or intensity of an unbound fluorescent substrate.

A further aspect of the present invention comprises a method of inhibiting proliferation of a cell in a subject comprising: administering to a subject a colloidal particle comprising a polymer core and a fluorescent substrate attached to an outer surface of the polymer core, wherein the emission and/or intensity of the fluorescent substrate are increased compared to the emission and intensity of the unbound fluorescent substrate; and exposing the subject to radiation, thereby inhibiting proliferation of a cell in the subject.

The foregoing and other aspects of the present invention will now be described in more detail with respect to other embodiments described herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

### BRIEF DESCRIPTION OF THE DRAWINGS

FIG. 1 shows a schematic illustration of the baited-particle enzyme extraction method: (a) the nanoparticles consist of poly(propargyl acrylate) (PA) and their surface modification with 9-(3-azidopropyl)-9H-carbazole (AC); (b) after adding particles to the protein solution, the CARDO enzyme is attracted and binds to the bait; (c) centrifugation is used to remove the particles with immobilized enzyme. After decanting and resuspension of the particles, the enzyme can be (d) separated by decanting, (e) released and assayed for its carbazole-degrading activity by elevation of temperature and introduction of cofactors.

FIG. 2 shows the change in photoluminescence spectra of PA/AC particles after 12 hour incubation at 30° C. with various concentrations of P. resinovorans CA10 lysate. Particle density was 3.43×10¹³/cm³ (diameter=83±12 nm) and (100 μL in 2.9 mL water) were combined with P. resinovorans CA10 lysate (5.6 μg/μL). Excitation wavelength at 295 nm.

FIG. 3 shows the proliferation of P. resinovorans CA10 with small molecule CAR (O) and PA/AC particle () based media during a 96 hour incubation at 23° C. Control growth performed with glucose medium (Δ).

FIG. 4 shows (a) predicted matrix-assisted laser desorption/ionization (MALDI) time-of-flight (TOF) mass spectrum of neat CARDO protein and (b) observed PA/AC particles with immobilized protein.

FIG. 5 shows matrix-assisted laser desorption/ionization (MALDI) time-of-flight (TOF) mass spectrum of purified (a) CARDO-R (b) CARDO-F, and (c) CARDO-O.

FIG. 6 shows sodium dodecyl sulfate polyacrylamide gel electrophoresis of whole cell lysate from P. resinovorans CA10 (lane 2) and PA/AC particle immobilized proteins (lane 3). For comparison, the purified CARDO components of CARDO-O (lane 4, 1 μg), CARDO-R (lane 5, 1.5 μg), and CARDO-F (lane 6, 2 μg) obtained through traditional multistep affinity purification methods using a polyhistidine-tag/nickel pair are presented. Lane 1 is the molecular weight marker.

FIG. 7 shows the measurement of activity with incubation time for proteins immobilized on PA/AC particles (), CA 10 lysate incubated with PA/AC particles (∇), neat CA 10 lysate (Δ), and non-specific proteins (O). Activity measured by the oxidation of NADH to NAD⁺ and assessed through the change in absorption of the supernatant at 340 nm.

FIG. 8 shows the reaction scheme for 9-(3-azidopropyl)-9H-carbazole (AC).

FIG. 9 shows the photoluminescence spectra (λₑₓ=295 nm) of 9H-carbazole incubated with CARDO complex for 60 minutes at 30° C. Decrease in PL intensity coincides with enzymatic breakdown of 9H-carbazole.

FIG. 10 shows normalized absorbance at 295 nm (peak absorbance of 9H-carbazole) after exposure to purified CARDO complex. Samples were incubated at 30° C., 23° C., 15° C. and 5° C.

FIG. 11 shows the fluorescence at λₑₓ=295 nm for PA/AC incubated with CA10 lysate for 12 h at various temperatures to illustrate the slowing of degradation by temperature decrease. From left to right, 25° C., 12° C., and 5° C.

FIG. 12 shows a schematic of various PA particles surface modified with (i) an azide-terminated indocyanine green (azICG), (ii) azICG and an azide-terminated PEG with a molecular weight of 1K (azPEG_{1K}), (iii) azICG and azPEG with a molecular weight of 5K (azPEG_{5K}). Particles modified through a CuAAC in water.

FIG. 13 shows (a) molar extinction coefficient (5 μg·mL⁻¹) (O) and photoluminescence () of azide-functionalized indocyanine green (azICG) in methanol. (b) Absorbance (O) and photoluminescence () spectra of PA/azICG particles in methanol. Excitation energy at a wavelength of 710 nm.

FIG. 14 shows (a) photoluminescence of PA/azICG/azPEG_{5K} particles dispersed in a PBS solution without BSA () and after 0.025 mM BSA (O) and 0.25 mM BSA (∇) had been added; time duration of ca. 4 days. Inset presents difference between initial and final emission spectra of particles with 0.25 mM BSA. (b) Increase in maximum photoluminescence intensity of particles composed of PA/azICG () and PA/azICG/azPEG with PEG of molecular weight of 1,000 (O) and 5,000 (∇) with varying amounts of added BSA; particles dispersed in a PBS solution with particle density of 1.259×10¹² cm⁻³. Excitation energy at a wavelength of 710 nm and emission intensity measured at 825 nm.

FIG. 15 shows (a) increase in photoluminescence intensity ratio of PA/azICG/azPEG_{1K} particles dispersed in a PBS solution with the addition of 0.014 mM BSA; time evolution of the intensity at 819 nm relative to the initial intensity. Inset presents photoluminescence of particles after 2 min (), 37 min (O), and 1174 min (∇). Excitation energy at a wavelength of 710 nm; particle density of 1.259×10¹² cm⁻³. (b) Optical image of fluorescence intensity of PA/azICG/azPEG₁K particles in deionized water (far left), PBS (center), and 2 h after the addition of 0.014 mM BSA to the PBS solution (far right); images taken with a Caliper Xenogen IVIS Lumina II XR Instrument with 745 nm excitation filter and ICG emission filter; particle density of 1.259×10¹² cm⁻³.

FIG. 16 shows proliferation of HepG2 cells after 4 days of incubation with neat PA (P) and PA/azICG/azPEG_{1K} (SMP) particles at concentrations of 9.45×10⁸ (8.97), 9.45×10¹⁰ (10.97), and 9.45×10¹² (12.97) particles·mL⁻¹. Each condition was tested in three replicates with the high/low values being presented as error bars. An asterisk indicates statistical significance from the control by ANOVA followed by Tukeys multiple comparisons test (p<0.01).

FIG. 17 shows proliferation of HepG2 cells with 24 h of incubation time with PA/azICG/azPEG_{1K} (SMP) particles at concentrations of 9.45×10¹⁰ (10.97) and 9.45×10¹² (12.97) particles·mL⁻¹ after exposure for 15 min to 780 nm light at a 0.04 mW·cm⁻² flux. Each condition was tested in three replicates with the high/low values being presented as error bars. Inset presents proliferation of neat cells with and without light exposure. An asterisk indicates statistical significance from the control by ANOVA followed by Tukeys multiple comparisons test (p<0.01).

FIG. 18 shows the synthetic route for 2-[(1E,3E,5E)-7-[(2E)-3-(3-azidopropyl)-1,1-dimethyl-1H,2H,3H-naphtho[2,1-b]pyrrol-2-ylidene]hepta-1,3,5-trien-1-yl]-1,1-dimethyl-3-(4-sulfonatobutyl)-1H-naphtho[2,1-b]pyrrol-3-ium (azICG).

FIG. 19 shows the synthetic route for azide-modified polyethylene glycol (azPEG).

### DETAILED DESCRIPTION OF THE INVENTION

The present invention will now be described more fully hereinafter. This invention may, however, be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. All publications, patent applications, patents and other references mentioned herein are incorporated by reference in their entirety. In the event of conflicting terminology, the present specification is controlling.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

As used herein, the transitional phrase “consisting essentially of” (and grammatical variants) is to be interpreted as encompassing the recited materials or steps “and those that do not materially affect the basic and novel characteristic(s)” of the claimed invention. See, In re Herz, 537 F.2d 549, 551-52, 190 U.S.P.Q. 461, 463 (CCPA 1976); see also MPEP §2111.03. Thus, the term “consisting essentially of” as used herein should not be interpreted as equivalent to “comprising.”

The term “about,” as used herein when referring to a measurable value such as an amount or concentration (e.g., the amount of a substrate), is meant to encompass variations of ±10%, ±5%, ±1%, ±0.5%, or even ±0.1% of the specified measurable value as well as the specified value. For example, “about X” where X is the measurable value, is meant to include X as well as variations of ±10%, ±5%, ±1%, ±0.5%, or even ±0.1% of X. A range provided herein for a measureable value may include any other range and/or individual value therein.

The present invention concerns a colloidal particle. “Colloidal particle” as used herein refers to a particle comprising a polymer core, wherein a surface of the polymer core comprises a click chemistry functional group. In particular embodiments of the present invention, a colloidal particle is a nanoparticle. The polymer core can comprise a polymer and/or copolymer. Exemplary polymers include, but are not limited to, poly(propargyl acrylate), polymethacrylate, poly(methyl-methacrylate), polystyrene, poly(propargyl acrylate-co-methacryalte), poly(propargyl acrylate-co-methyl-methacrylate), poly(propargyl acrylate-co-styrene), and any combination thereof. In particular embodiments of the present invention, the polymer core of a colloidal particle comprises, consists essentially of, or consists of poly(propargyl acrylate).

A “click chemistry functional group” or “click functionality” as used herein refer to a functional group that can be used in a click chemistry reaction. A “click chemistry reaction” as used herein refers to a reaction that can provide one or more of the following features: be modular, give a high chemical yield, generate only inoffensive byproducts, be stereospecific, favor a reaction with a single reaction product, use no solvent or use a solvent that is benign or easily removed (preferably water), and/or provide simple product isolation by non-chromatographic methods.

Click chemistry reactions are known to those of ordinary skill in the art and include, but are not limited to addition reactions, cycloaddition reactions, radical-mediated reactions, and nucleophilic substitutions. Exemplary cycloaddition reactions include, but are not limited to, Huisgen 1,3-dipolar cycloadditions, copper catalyzed azide-alkyne cycloadditions, and Diels-Alder reactions. Exemplary addition reactions include, but are not limited to, addition reactions to carbon-carbon double bonds such as epoxidation and dihydroxylation. Exemplary radical-mediated reactions include, but are not limited to, thiol-ene and thiol-yne radical reactions. Exemplary nucleophilic substitution reactions include, but are not limited to, nucleophilic substitution to strained rings such as epoxy and aziridine compounds, thiol-epoxy reactions, thiol-isocyanate reactions, and thiol-Michael addition reactions. Additional exemplary click chemistry reactions include, but are not limited to, reactions which form urea or an amide. A description of click chemistry can be found in Huisgen, Angew. Chem. Int. Ed., Vol. 2, No. 11, 1963, pp. 633-696; Lewis et al., Angew. Chem. Int. Ed., Vol. 41, No. 6, 2002, pp. 1053-1057; Rodionov et al., Angew. Chem. Int. Ed., Vol. 44, 2005, pp. 2210-2215; Punna et al., Angew. Chem. Int. Ed., Vol. 44, 2005, pp. 2215-2220; Li et al., J. Am. Chem. Soc., Vol. 127, 2005, pp. 14518-14524; Himo et al., J. Am. Chem. Soc., Vol. 127, 2005, pp. 210-216; Noodleman et al., Chem. Rev., Vol. 104, 2004, pp. 459-508; Sun et al., Bioconjugate Chem., Vol. 17, 2006, pp. 52-57; and Fleming et al., Chem. Mater., Vol. 18, 2006, pp. 2327-2334, the contents of which are incorporated by reference herein in their entireties.

Exemplary click chemistry functional groups include, but are not limited to, alkenes, alkynes, azides, thiols, epoxy groups, isocyanates, or any combination thereof. In particular embodiments of the present invention, a surface of the polymer core of a colloidal particle of the present invention comprises an alkyne and/or an azide. In certain embodiments of the present invention, the outer surface of the polymer core of a colloidal particle of the present invention comprises an alkyne and/or azide that is surface-accessible.

“Alkynyl” or “alkyne” as used herein alone or as part of another group, refers to a straight or branched chain hydrocarbon containing 1 to 30 carbon atoms (for lower alkynyl, 1 to 4 carbon atoms) which include at least one triple bond in the hydrocarbon chain. In some embodiments, the alkynyl group may contain 2, or 3 up to 4, 5, 6, 7, 8, 9, 10, 11, 12, 13, 14, 15, 16, 17, 18, 19, 20, 21, 22, 23, 24, 25, 26, 27, 28, 29, or 30 carbon atoms. Representative examples of alkynyl include, but are not limited to, 2-propynyl, 3-butynyl, 2-butynyl, 4-pentynyl, 3-pentynyl, and the like. The term “alkynyl” or “lower alkynyl” is intended to include both substituted and unsubstituted alkynyl or lower alkynyl unless otherwise indicated.

“Azide” as used herein refers to the chemical group —N₃.

The colloidal particle of the present invention can have a particle diameter of about 10 to greater than about 1,000 nm or any range therein, such as about 10 to 500 nm, about 70 to about 750 nm, about 25 to about 200 nm, about 10 to about 80 nm, about 50 to about 150 nm, or about 60 to about 110 nm. In some embodiments of the present invention, a colloidal particle is a nanoparticle. A “nanoparticle” as used herein, refers to a colloidal particle having at least one dimension that is less than about 100 nm. In particular embodiments of the present invention, the colloidal particle of the present invention has a particle diameter of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, or 150 nm, or any range therein. In certain embodiments of the present invention, the colloidal particle has a particle diameter of about 70 to about 90 nm.

The colloidal particle of the present invention can be prepared by methods known to those of ordinary skill in the art. For example, in some embodiments of the present invention the colloidal particle can be prepared using an emulsion polymerization procedure, a modified emulsion polymerization procedure, a core-shell emulsion polymerization, a suspension polymerization procedure, or any combination thereof. The click chemistry functional group can be present on a surface of the polymer core as a result of the preparation of the colloidal particle and/or as a result of a chemical reaction functionalizing the polymer core of the colloidal particle to comprise a click chemistry functional group after the preparation of the polymer core. In particular embodiments of the present invention, a click chemistry functional group is present on the outer surface of a polymer core as a result of the preparation of the colloidal particle using a method such as, but not limited to, standard emulsion polymerization.

The colloidal particle of the present invention can be uncrosslinked and/or crosslinked. The colloidal particle of the present invention can be crosslinked using methods known to those of ordinary skill in the art. Exemplary methods of crosslinking a colloidal particle of the present invention include, but are not limited to, the use of crosslinking reagents, such as divinyl benzene, during and/or after the preparation of the colloidal particle. In particular embodiments of the present invention, the colloidal particle is crosslinked.

According to some embodiments of the present invention, the invention can comprise, consist essentially of, or consist of a suspension of colloidal particles. The term “suspension” as used herein refers to one or more particles being suspended or dispersed in an aqueous solution (e.g., water, such as deionized water) or a non-aqueous solution (e.g., an organic or inorganic solvent). The suspension of colloidal particles can be polydisperse (i.e., the particles are not consistent in size and/or shape) or monodisperse (i.e., the particles have a similar size and/or shape). A monodispersion of colloidal particles can be prepared by known methods, such as, but not limited to, dialysis and/or ion-exchange chromatography. When the suspension of the present invention is monodisperse, the colloidal particles in the monodispersion can have an average diameter that varies by ±1 to ±20 nm, or any range there, such as ±2 to ±15 nm or ±5 to ±10 nm. In some embodiments of the present invention, the colloidal particles in a monodispersion have an average diameter that varies by ±1, 2, 3, 4, 5, 6, 7, 8, 9, 10, 11, 12, 13, 14, 15, 16, 17, 18, 19, or 20 nm, or any range therein.

In particular embodiments of the present invention, a surface of the polymer core of a colloidal particle is modified with a substrate (i.e., a surface modified colloidal particle). “Modified” and grammatical variants thereof, as used herein in reference to a surface of the polymer core, refer to attaching, binding (e.g., covalent binding, noncovalent binding, etc.), coupling, and the like, a substrate to a surface of the polymer core of a colloidal particle of the present invention. In certain embodiments of the present invention, the surface modified is the outer surface of the colloidal particle's polymer core. Advantageously, according to some embodiments of the present invention, the polymer core surface of a colloidal particle of the present invention can be modified with a substrate in an aqueous solution, such as, but not limited to, water (e.g., deionized water) and/or a surface modified colloidal particle of the present invention can be prepared using a method that is fast, efficient, and/or able to be scaled up for large preparations of surface modified colloidal particles.

In certain embodiments of the present invention, the outer surface of a polymer core is modified using a click chemistry reaction. The click chemistry reaction can be carried out in an aqueous solution, such as water, or in an organic or inorganic solvent, such as but not limited to, tetrahydrofuran (THF), dimethyl sulfoxide (DMSO), and dimethylformamide (DMF). In some embodiments of the present invention, the outer surface of a colloidal particle's core is modified using a click chemistry cycloaddition reaction, such as, but not limited to an azide/alkyne cycloaddition and/or the outer surface of a colloidal particle's core is modified using a click chemistry reaction comprising thiol-yne radical mediated coupling. When an azide/alkyne cycloaddition is utilized to modify the outer surface of a colloidal particle's core, a catalyst can be used. Exemplary catalysts include, but are not limited to, a copper catalyst (e.g., a copper(I) catalyst, a copper(II) catalyst, etc.), a ruthenium catalyst (e.g., a ruthenium(II) catalyst, a ruthenium(III) catalyst, etc.) a cobalt catalyst (e.g., a cobalt(II) catalyst, a cobalt(III) catalyst, etc.), or any combination thereof. In particular embodiments of the present invention, a catalyst system comprising copper(II) sulfate (CuSO₄) or copper(I) sulfate (Cu₂SO₄) and sodium ascorbate is used in an azide/alkyne cycloaddition.

The click chemistry reaction can be carried out for any length of time. In some embodiments of the present invention, the click chemistry reaction is carried out for a period of time of about 1 minute to about 4 days, or any range therein, such as about 2 minutes to about 1 hour, about 5 minutes to about 30 minutes, or about 1 day to about 2 days. In particular embodiments of the present invention, the click chemistry reaction is carried out for about 1 minute, 5 minutes, 10 minutes, 15 minutes, 30 minutes, 1 hour, 2 hours, 5 hours, 10 hours, 15 hours, 20 hours, 1 day, 2 days, 3 days, or 4 days, or any range therein. In certain embodiments of the present invention, the click chemistry reaction is carried out for a length of time sufficient to achieve a desired grafting density.

The grafting density of a substrate on a surface of a colloidal particle's core can be about 0.5 to about 5 substrate/nm², or any range therein, such as about 1.5 to about 4 substrate/nm² or about 2 to about 3 substrate/nm². In particular embodiments of the present invention, a substrate is grafted onto a surface of a colloidal particle's core with a grafting density of about 0.5, 1, 1, 5, 2, 2.5, 3, 3.5, 4, 4.5, or 5 substrate/nm², or any range therein. In particular embodiments of the present invention, a substrate is present on the outer surface of a colloidal particle's core in grafting density of about 1.5 to about 3.5 substrate/nm².

The click chemistry reaction can be carried out at a temperature of about 5° C. to about 100° C., or any range therein, such as about 10° C. to about 70° C., about 35° C. to about 55° C., about 10° C. to about 35° C., or about 20° C. to about 30° C. In particular embodiments of the present invention, the click chemistry reaction is carried out at a temperature of about 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., or 100° C., or any range therein. In certain embodiments of the present invention, the click chemistry reaction is carried out at a temperature of about 25° C. to about 30° C.

Exemplary substrates that can be attached to a surface of a colloidal particle's core of the present invention, include but are not limited to, organic compounds, inorganic compounds, peptides, proteins, enzyme substrates, ligands, antibodies, antigens, DNA, RNA, polymers, fluorescent compounds, one half of a binding pair, or combinations thereof. “Binding pair” as used herein refers to any molecule that is able to specifically bind to another molecule, such as, but are not limited to, streptavidin to biotin and avidin to biotin. One or more different substrates can be attached a colloidal particle's core of the present invention, such as 2, 3, 4, or 5, or more substrates. In particular embodiments of the present invention, one or two substrates are attached to a colloidal particle's core of the present invention.

In particular embodiments of the present invention, the outer surface of a colloidal particle's core is modified using a click chemistry reaction to attach a substrate upon which an enzyme is known or believed to act upon. In certain embodiments of the present invention, the substrate is an organic compound, an inorganic compound, a peptide, and/or a protein.

According to some embodiments of the present invention, the substrate is an organic compound, such as, but not limited to, a small organic compound. A “small organic compound,” as used herein, refers to an organic compound having a molecular weight of more than about 10 Daltons and less than about 5,000 Daltons, or any range therein, such as about 40 Daltons to about 3,000 Daltons, about 100 Daltons to about 2,500 Daltons, or about 100 Daltons to about 1,000 Daltons. A small organic compound can be natural, modified, or synthetic. Small organic compounds of the present invention can comprise functional groups necessary for structural interaction with proteins, for example hydrogen bonding. Exemplary functional groups include, but are not limited to alkyl, alkenyl, hydroxyl, alkoxy, cycloalkyl, cycloalkenyl, halo, sulfhydryl, thio, thioalkyl, cyano, carbonyl, carboxyl, amino, aminoalkyl, alkylamino, nitro, heteroaryl, phosphoryl, and aryl groups. A small organic compound can comprise saturated or unsaturated cyclical carbon or heterocyclic structures substituted with one or more functional groups and/or aromatic or polyaromatic structures substituted with one or more functional groups. Exemplary small organic compounds include, but are not limited to, pharmaceuticals, sugars, fatty acids, steroids, saccharides, purines, pyrimidines, derivatives, structural analogs, or combinations thereof.

One aspect of the present invention comprises a method for isolating a target molecule from a mixture. “Target molecule,” as used herein, refers to a molecule that binds or attaches to a substrate on a surface of a colloidal particle's core. In particular embodiments of the present invention, a target molecule specifically binds to a substrate on a surface of a colloidal particle's core. Exemplary target molecules include, but are not limited to, peptides, proteins, enzyme substrates, ligands, antibodies, antigens, DNA, RNA, the other half of a binding pair, or combinations thereof. In particular embodiments of the present invention, a substrate-modified colloidal particle of the present invention can isolate a target molecule that is present in a crude mixture (i.e., a contaminated or unpurified mixture), such as, but not limited to, a crude cell lysate. In certain embodiments of the present invention, the target molecule is a protein. As those of ordinary skill in the art will appreciate, a protein that attaches to a substrate-modified colloidal particle of the present invention can be a specific protein (e.g., one species) or a certain type of protein (e.g., multiple species that have a common feature) that can have an affinity for the substrate and by removing the colloidal particle with the attached protein from the mixture, the protein can be isolated.

In some embodiments of the present invention, a method for isolating a target molecule from a mixture is provided comprising providing a colloidal particle comprising a polymer core and a substrate attached to an outer surface of the polymer core, wherein the substrate has an affinity for a target molecule; adding the colloidal particle to a mixture comprising the target molecule or believed to comprise the target molecule; incubating the colloidal particle with the mixture for a period of time; and removing the colloidal particle from the mixture, thereby isolating the target molecule from the mixture.

The incubation step can be carried out for a period of time of about 1 minute to about 24 hours, or any range therein, such about 5 minutes to about 3 hours, about 1 hour to about 15 hours, or about 30 minutes to about 5 hours. In particular embodiments of the present invention, the incubation step is carried out for about 1 minute, 5 minutes, 15 minutes, 30 minutes, 45 minutes, 1 hour, 2 hours, 4 hours, 6 hours, 8 hours, 10 hours, 12 hours, 14 hours, 16 hours, 18 hours, 20 hours, 22 hours, or 24 hours, or any range therein. In certain embodiments of the present invention, the incubation step is carried out for about 1 hour.

The incubation step can be carried out at a temperature of about 0° C. to about 30° C. In particular embodiments of the present invention, the incubation step is carried out at a temperature of about 0° C., 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., or 30° C., or any range therein. In certain embodiments of the present invention, the incubation step is carried out at about 5° C.

The removing step can be carried out by methods known in the art, such as, but not limited to centrifugation, decantation, resuspension, washing, dialyzing, or any combination thereof. In particular embodiments of the present invention, the removing step comprises centrifuging the mixture with the colloidal particles, decanting the resulting liquid phase, and resuspending the solid phase comprising the colloidal particles. The removing step can be repeated two or more times, such as 2, 3, 4, or more times. In some embodiments of the present invention, non-specific binding of non-targeted compounds can be removed by washing steps, such as but not limited to, mild washing with a sodium chloride solution, which can optionally be followed by centrifuging, decanting and/or resuspending the colloidal particles.

In some embodiments of the present invention, the method further comprises releasing a target molecule from a colloidal particle. In particular embodiments of the present invention, a colloidal particle of the present invention selectively releases a target molecule (i.e., the colloidal particle primarily releases the target molecule when exposed to specific conditions and/or compounds). The releasing step can be carried out by methods known in the art, such as, but not limited to, increasing the temperature, adding a compound (e.g., an organic compound, a biological molecule, such as a peptide or protein), enzymatic cleavage, or combinations thereof. In particular embodiments of the present invention, a target molecule is released from a colloidal particle of the present invention by increasing the temperature and/or adding a cofactor to the colloidal particles. Exemplary cofactors include, but are not limited to, metals (including metal ions, such as magnesium and zinc, and metal complexes such as iron sulfur complexes), biotin, coenzyme A, coenzyme B, coenzyme M, coenzyme Q, nicotinamide adenine dinucleotide (NAD⁺), nicotinamide adenine dinucleotide phosphate (NADP⁺), thiamine pyrophosphate (TPP), lipoamide, flavin adenine dinucleotide (FAD), adenosine monophosphate (AMP), pyridoxal phosphate, cobalamine, ascorbic acid, flavin mononucleotide, metanofuran, glutathione, nucleotide sugars, or combinations thereof.

In particular embodiments of the present invention, the method of isolating a target molecule from a mixture using a surface modified colloidal particle of the present invention, results in the isolated target molecule having a bioactivity similar (i.e., at least about 80%) to its bioactivity prior to binding the colloidal particle. In certain embodiments of the present invention, the isolated target molecule has a bioactivity that is at least about 80%, 81%, 82%, 83%, 84%, 85%, 86%, 87%, 88%, 89%, 90%, 91%, 92%, 93%, 94%, 95%, 96%, 97%, 98%, 99%, 99.5%, 99.7%, or 100%, or any range therein, of the bioactivity of the target molecule before binding to the colloidal particle. In certain embodiments of the present invention, the bioactivity of an isolated target molecule is measured after the target molecule is released from a colloidal particle of the present invention using biological and/or chemical methods known to those of skill in the art and after subsequent removal of the unbound colloidal particle of the present invention using biological and/or chemical methods known to those of skill in the art.

According to some embodiments of the present invention, a method for detecting binding and/or a binding affinity of a target molecule is provided comprising providing a colloidal particle comprising a polymer core and a substrate attached to an outer surface of the polymer core, wherein the substrate has an affinity for a target molecule; adding the colloidal particle to a mixture; incubating the colloidal particle with the mixture for a period of time; removing the colloidal particle from the mixture, and detecting the binding and/or binding affinity of the target molecule. In some embodiments of the present invention, the target molecule is unknown and/or the binding affinity of the target molecule to the substrate is unknown. The detecting step can be carried out by methods known to those of skill in the art, such as, but not limited to, chemical and/or biological assays and/or techniques including high-performance liquid chromatography, mass spectrometry, nuclear magnetic resonance, gel electrophoresis, or combinations thereof.

A further aspect of the present invention comprises a method of analyzing and/or identifying one or more enzymes in a pathway, comprising providing a colloidal particle comprising a polymer core and an enzyme substrate attached to an outer surface of the polymer core, wherein the enzyme substrate has an affinity for a target molecule; adding the colloidal particle to a mixture comprising the target molecule or believed to comprise the target molecule; incubating the colloidal particle with the mixture for a period of time; removing the colloidal particle from the mixture; and detecting and/or identifying the target molecule. In particular embodiments of the present invention a method is provided for identifying one or more enzymes in a metabolic pathway.

Another aspect of the present invention comprises a colloidal particle comprising a fluorescent substrate attached to an outer surface of the colloidal particle's core. In some embodiments of the present invention, the fluorescence emission of a fluorescent substrate attached to an outer surface of a colloidal particle's core can decrease by about 50% or more, such as by about 60%, 70%, 80%, or more, compared to the fluorescence emission of the unbound fluorescent substrate. In certain embodiments of the present invention, upon attachment of the fluorescent substrate to the colloidal particle, the fluorescence emission of the fluorescent substrate decreases by about 50% or more compared to the fluorescence emission of the unbound fluorescent substrate.

According to some embodiments of the present invention, the fluorescence emission and/or intensity of a fluorescent substrate attached to an outer surface of a colloidal particle's core can be increased compared to the fluorescence emission and/or intensity of the unbound fluorescent substrate. Methods of measuring fluorescence emission and intensity are known to those of skill in the art and include, but are not limited to, the use of UV/vis spectroscopy.

The fluorescence emission of a fluorescent substrate attached to a colloidal particle's core can be increased by about 30% to about 100% or more, or any range therein, compared to the emission of the unbound fluorescent substrate. In particular embodiments of the present invention, the fluorescence emission of a fluorescent substrate can be increased by about 30%, 35%, 40%, 45%, 50%, 55%, 60%, 65%, 70%, 75%, 80%, 85% 90%, 95%, 100% or more, or any range therein. In certain embodiments of the present invention, the fluorescence emission of a fluorescent substrate can be increased by at least about 50% compared to the unbound fluorescent substrate.

In certain embodiments of the present invention, the emission of a fluorescent substrate can be increased by contacting a biomolecule, such as, but not limited to, a protein, peptide, DNA, or RNA, to a colloidal particle with a fluorescent substrate attached to the outer surface of its polymer core. The biomolecule can, in some embodiments, form a complex with a substrate modified colloidal particle of the present invention. In particular embodiments of the present invention, the emission of a fluorescent substrate can be increased by contacting serum albumin (e.g., bovine and/or human) and/or an RNA aptamer to a colloidal particle with a fluorescent substrate attached to the outer surface of its polymer core. In certain embodiments of the present invention, the fluorescence emission of a fluorescent substrate attached to a colloidal particle's core is increased by at least about 50% (compared to the emission of the unbound fluorescent substrate and/or compared to the emission of the fluorescent substrate bound to the colloidal particle prior to contact with a biomolecule) after contacting the substrate modified colloidal particle with a protein, such as, but not limited to, serum albumin. In particular embodiments of the present invention, the fluorescence emission of a fluorescent substrate attached to a colloidal particle's core is increased by a factor of about 1, 2, 3, 4, 5, 6, 7, 8, 9, 10, 11, 12, 13, 14, 15, 16, 17, 18, 19, or 20, or any range therein, (compared to the emission of the unbound fluorescent substrate and/or compared to the emission of the fluorescent substrate bound to the colloidal particle prior to contact with a biomolecule) after contacting the substrate modified colloidal particle with a biomolecule.

The fluorescence intensity ratio of a fluorescent substrate attached to a colloidal particle's core can be increased by about 1 to about 20 or more, or any range therein compared to the fluorescence intensity ratio of the unbound fluorescent substrate. In particular embodiments of the present invention, the fluorescence intensity ratio of a fluorescent substrate can be increased by about 1, 2, 3, 4, 5, 6, 7, 8, 9, 10, 11, 12, 13, 14, 15, 16, 17, 18, 19, 20 or more, or any range therein. In certain embodiments of the present invention, the fluorescence intensity ratio of a fluorescent substrate can be increased by at least about 5 compared to the fluorescence intensity ratio of the unbound fluorescent substrate.

In some embodiments of the present invention, the fluorescence intensity ratio of a fluorescent substrate can be increased by attaching a second substrate to the outer surface of a colloidal particle's core comprising a fluorescent substrate attached to its outer surface. In particular embodiments of the present invention, a polymer is the second substrate attached to the outer surface of a colloidal particle's core comprising a fluorescent substrate attached to its outer surface. Exemplary polymers include, but are not limited to, poly(ethylene glycol); polyethylenimine; poly-L-lysine, polyvinylpyrrolidone; polyvinyl alcohol; poly(4-vinylpyridine); poly-n-isopropylacrylamide; polyacrylamide; poly(lactic acid); silicones; naturally-derived polymers such as hyaluronan, chitosan, agarose, and cellulose; or combinations thereof. In certain embodiments of the present invention, the polymer is polyethylene glycol. Poly(ethylene glycol) can have a molecular weight of about 100 to about 10,000 or more, or any range therein, such as about 500 to about 7,000 or about 1,000 to about 5,000. In particular embodiments of the present invention, poly(ethylene glycol) has a molecular weight of about 500, 1,000, 1,500, 2,000, 2,500, 3,000, 3,500, 4,000, 4,500, 5,000, 5,500, 6,000, 6,500, 7,000, 7,500, 8,000, 8,500, 9,000, 9,500, 10,000 or more, or any range therein. According to some embodiments of the present invention, poly(ethylene glycol) and a fluorescent substrate are each attached to the outer surface of a colloidal particle's core and the fluorescence intensity ratio of the fluorescent substrate can be increased by about 1 to about 20, or any range therein compared to the fluorescence intensity ratio of the unbound fluorescent substrate.

“Fluorescent substrate” as used herein refers to a chemical compound that when excited by exposure to a particular wavelength of light, emits light (i.e., fluoresces), at a different wavelength of light. Numerous fluorescent substrates are known in the art and may be utilized in the present invention. Exemplary fluorescent substrates include, but are not limited to, fluoresceins, such as TET (Tetramethyl fluorescein), 2′,7′-dimethoxy-4′,5′-dichloro-6-carboxyfluorescein (JOE), 6-carboxyfluorescein (HEX) and 5-carboxyfluorescein (5-FAM); phycoerythrins; resorufin dyes; coumarin dyes; rhodamine dyes, such as 6-carboxy-X-rhodamine (ROX); cyanine dyes; BODIPY dyes; quinolines; pyrenes; N,N,N′,N′-tetramethyl-6-carboxyrhodamine (TAMRA); acridine; stilbene; Texas Red; as well as derivatives thereof. In certain embodiments of the present invention, the fluorescent substrate is one that can be used in photodynamic therapy.

In particular embodiments of the present invention, the fluorescent substrate is a near-infrared emitter (i.e., the fluorescent substrate emits light in the near-infrared region of the light spectrum of about 700 nm to about 1400 nm). Exemplary near-infrared emitters include, but are not limited to, cyanine dyes, such as indocyanine green, squaraine dyes, phthalocyanine dyes, porphyrin dyes, BODIPY, derivatives thereof, or any combination thereof. In certain embodiments of the present invention, the near-infrared emitter is indocyanine green. In other embodiments of the present invention, the near-infrared emitter is a squaraine dye and/or a derivative thereof. Exemplary squarine dyes include, but are not limited to, 3-(3-azidopropyl)-2-{[(1E)-3-{[(2E)-3-(3-azidopropyl)-1,1-dimethyl-1H,2H,3H-benzo[e]indol-2-ylidene]methyl}-2-oxido-4-oxocyclobut-2-en-1-ylidene]methyl}-1,1-dimethyl-1H-benzo[e]indol-3-ium (3)}, {2-{[(1E)-3-{[(2Z)-3-(3-azidopropyl)-1,1-dimethyl-1H,2H,3H-benzo[e]indol-2-ylidene]methyl}-2-hydroxy-4-oxocyclobut-2-en-1-ylidene]methyl}-1,1-dimethyl-3-(4-sulfonatobutyl)-1H-benzo[e]indol-3-ium (7)}, and (4Z)-2-{(Z)-[1-(3-azidopropyl)-3,3-dimethyl-1,3-dihydro-2H-indol-2-ylidene]methyl}-4-{[1-(3-azidopropyl)-3,3-dimethyl-3H-indolium-2-yl]methylidene}-3-oxocyclobut-1-en-1-olate.

A further aspect of the present invention provides a method of inhibiting proliferation of a cell in a subject comprising administering to a subject a colloidal particle comprising a polymer core and a fluorescent substrate attached to an outer surface of the polymer core, wherein the emission and/or intensity of the fluorescent substrate are increased compared to the emission and/or intensity of the unbound fluorescent substrate; and exposing the subject to radiation, thereby inhibiting proliferation of a cell in the subject. A colloidal particle comprising a polymer core and a fluorescent substrate attached to an outer surface of the polymer core may be administered to a subject in an amount sufficient to inhibit proliferation of a cell.

“Inhibition of proliferation” and grammatical variations thereof as used herein refer to a decrease in the rate of proliferation (e.g., a decrease or slowing in the rate of cellular division), cessation of proliferation (e.g., entry into GO phase or senescence), and/or death of a cell, including necrotic cell death or apoptosis. As those skilled in the art will recognize, by exposing a subject administered a colloidal particle comprising a fluorescent substrate to radiation this can cause the fluorescent substrate to fluoresce and when oxygen is present, this can result in the formation of a singlet oxygen (¹O₂), which is cytotoxic. In certain embodiments of the present invention, the exposing step comprises exposing the subject to radiation of about 700 nm to about 1400 nm, or any range therein, such as about 700 nm to about 1000 nm or about 700 nm to about 850 nm.

The rate of cell proliferation may be inhibited or slowed down by about 5%, 10%, 15%, 20%, 25%, 30%, 35%, 40%, 45%, 50%, 55%, 60%, 65%, 70%, 75%, 80%, 85%, 90%, 95%, 98%, or more compared to the rate the cells were previously proliferating at or compared to the rate of cellular proliferation for other cells that have been matched by suitable criteria, including but not limited to, tissue type, doubling rate or metastatic potential.

The present invention finds use in both veterinary and medical applications. Suitable subjects of the present invention include, but are not limited to avians and mammals. The term “avian” as used herein includes, but is not limited to, chickens, ducks, geese, quail, turkeys, pheasants, parrots, parakeets, macaws, cockatiels, canaries, and finches. The term “mammal” as used herein includes, but is not limited to, primates (e.g., simians and humans), non-human primates (e.g., monkeys, baboons, chimpanzees, gorillas), bovines, ovines, caprines, ungulates, porcines, equines, felines, canines, lagomorphs, pinnipeds, rodents (e.g., rats, hamsters, and mice), etc. In some embodiments of the present invention the subject is a mammal and in certain embodiments the subject is a human. Human subjects include both males and females and subjects of all ages including fetal, neonatal, infant, juvenile, adolescent, adult, and geriatric subjects.

Exemplary cells whose proliferation or growth may be inhibited include, but are not limited to, adult cells of any type or cancer cells such as skin cancer cells, small cell lung cancer cells, non-small cell lung cancer cells, testicular cancer cells, lymphoma cells, leukemia cells, Kaposi's sarcoma cells, esophageal cancer cells, stomach cancer cells, colon cancer cells, breast cancer cells, endometrial cancer cells, ovarian cancer cells, central nervous system cancer cells, liver cancer cells and prostate cancer cells.

Another aspect of the present invention provides a method of treating cancer in a subject comprising administering to a subject a colloidal particle comprising a polymer core and a fluorescent substrate attached to an outer surface of the polymer core, wherein the emission and/or intensity of the fluorescent substrate are increased compared to the emission and/or intensity of the unbound fluorescent substrate; and exposing the subject to radiation. In particular embodiments of the present invention a method of treating cancer in a subject is provided comprising photodynamic therapy. The administering step may be carried out to deliver a therapeutically effective amount of a colloidal particle comprising a polymer core and a fluorescent substrate attached to an outer surface of the polymer core. As used herein, the term “therapeutically effective amount” refers to an amount of a colloidal particle of the present invention that elicits a therapeutically useful response in the subject. Those skilled in the art will appreciate that the therapeutic effect need not be complete or curative, as long as some benefit is provided to the subject.

The term “treating” and grammatical variants thereof, as used herein, refer to any type of treatment that imparts a benefit to a subject, including preventing, delaying, and/or reducing the onset and/or progression of one or more symptom(s) and/or condition(s), reducing the severity of one or more symptom(s) and/or condition(s), etc. Those skilled in the art will appreciate that the benefit imparted by the treatment according to the methods of the present invention is not necessarily meant to imply cure or complete prevention (e.g., no detectable cancerous cells) and/or abolition of the symptom(s) and/or condition(s).

The colloidal particles of the present invention can be administered to a subject by any suitable route. The most suitable route in any given case will depend on the nature and severity of the condition being treated and on the colloidal particle composition or pharmaceutical formulation being administered. In certain embodiments of the present invention, the colloidal particles of the present invention are administered in the form of a composition comprising the colloidal particles and optionally one or more pharmaceutical carriers and/or excipients, and can be delivered by parenteral administration (e.g., intramuscular (e.g., skeletal muscle), intravenous, subcutaneous, intradermal, intrapleural, intracerebral and/or intra-arterial, intrathecal). In some embodiments of the present invention, the colloidal particles of the present invention can be administered directly to an afflicted site (e.g., directly to a tumor).

Methods of exposing a subject to radiation are known to those of skill in the art, such as, but not limited to, exposing a subject to light from a laser, optical fibers or cables, light-emitting diodes, or any combination thereof. The subject's whole body and/or localized areas of the body may be subjected to radiation. In particular embodiments of the present invention, a localized area of a subject's body (e.g., the area where the tumor is located and/or the tumor itself) are subjected to radiation.

The present invention is explained in greater detail in the following non-limiting Examples.

### EXAMPLES

### Example 1

There is widespread interest in developing robust, flexible platforms which can be employed in both the verification of proposed metabolic pathways for specific enzymatic chemical reactions and as a means to harvest these specific enzymes from a mixture. Ligand-immobilization techniques represent a powerful tool for downstream processing of enzyme biotechnologies, both in terms of enzyme identification and recovery [1-3]. However, the most common methods to extract and concentrate enzymes use covalent immobilization of the enzyme to a bulk surface [4-6]. Covalent binding of enzymes to the substrate hinders the recovery and recycling of the enzymes [7]. Core-shell particles are also a common covalent-immobilization filter for low molecular weight proteins, but these methods require complex chemistries and fine control of shell porosity to allow proteins to access their specific ligand [8, 9]. In addition, many of these covalent immobilization methods employ an indiscriminate binding chemistry, e.g. thiol-reactivity, which results in a non-specific enzyme immobilization, resulting in the neglect of unknown members of the proteome [10]. An alternative approach would employ substrate or metabolite infused particles which would be capable of treating dilute solutions or mixtures containing only minute amounts of target molecules in the presence of other accompanying compounds.

Presented is a general strategy that employs sub-100 nm particles on which a substrate for a unique protein is “tethered”. We demonstrate that these “baited” nanoparticles can immobilize a specific protein type then release them for subsequent analysis without a loss of bioactivity. The principle of this substrate-baited separation method is general and applicable to many systems. Particulate carriers bearing a general substrate or metabolite are mixed with a solution or mixture, e.g., crude cell lysates, plasma, cultivation media, or environmental samples, containing the target or unknown metabolic enzymes. Following an incubation period during which the target compounds bind to the decorated particles, the particles with the immobilized target compounds are easily removed from the mixture using centrifugation. After washing out the contaminants, the isolated target protein can be eluted or reactivated from the particles and used for further work. Due to the simple synthesis and rapid decoration of the particles employed in this approach, this process can be tailored for a range of primary substrate/metabolites and their corresponding target proteins and produced in quantities appropriate for applications in large scale separation technologies, e.g., fluidized bed systems.

Metabolic enzymes are a large class of proteins in which their biochemical functions are veiled and there is a need to establish their proposed functions as well as discover unforseen activities [10, 12, 13]. Xenobiotic metabolism is a good example of a complicated, unknown metabolic network that would elucidate the complications of metabolomics, specifically the inordinate number of metabolites as compared to metabolic enzymes [14, 15]. Xenobiotic metabolism includes microbial biodegradation pathways[16] and drug metabolism in mammals [17]. The model system employed to demonstrate this strategy for extraction of xenobiotic metabolizing enzymes utilized Pseudomonas resinovorans CA10. This specific bacterial strain is a source of heterocyclic aromatic degrading enzymes[18], a critical biotransformation for numerous bioremediation and natural product synthesis processes [19-25].

In the current effort, an azide-modified carbazole was attached to crosslinked and inert poly(propargyl acrylate) (PA) particles following a previously presented procedure[26]. Briefly, the preparation of aqueous-phase nanoparticles that are surface-functionalized with a carbazole substrate was achieved through a “click” chemistry approach [27-29]. The carbazole decorated particles (PA/AC) were utilized to bind and harvest carbazole 1-9a dioxygenase (CARDO) from P. resinovorans CA10 lysate. The specificity of the PA/AC method was then compared to traditional nickel-bead methods. This method illustrates the power that can be harnessed from the diversity of a “clickable” protein harvesting substrate. Through this facile method of modifying the surface of aqueous-phase particles, a range of potential substrates and metabolites can be attached to particles at high grafting densities that are only limited by the steric interactions of the attached moieties. The subsequent steps of the enzyme recognition and harvesting can then take place in a single test tube, in which the immobilization of the enzyme on the particle and release is studied to assess the affinity of the enzyme for the substrate and the ability to ultimately harvest and recycle the enzyme.

### Results and Discussion

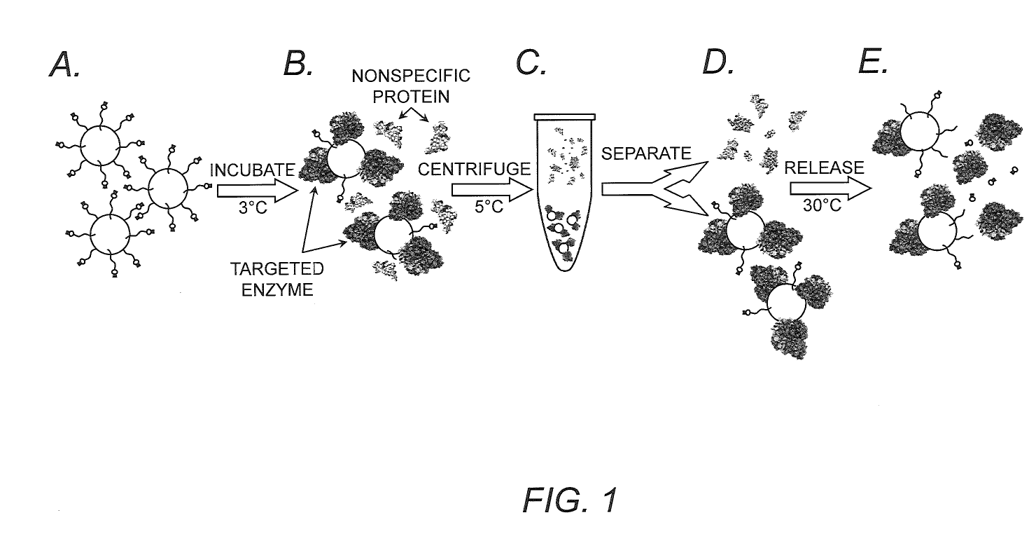

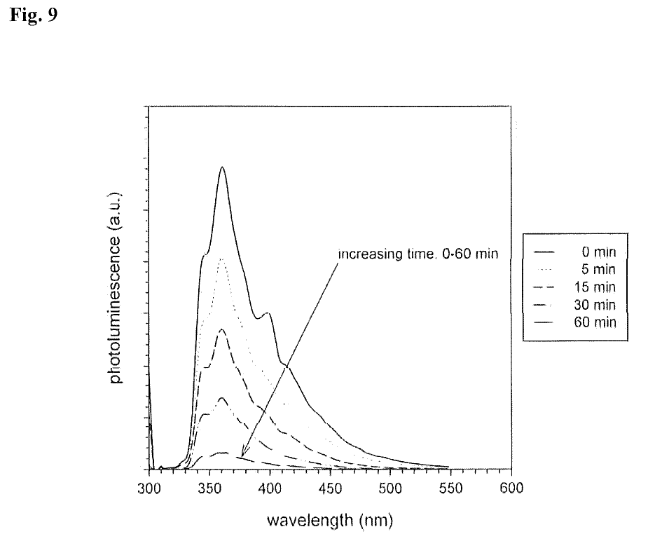

FIG. 1 presents the schematic of the “catch and release” strategy for protein harvesting. The PA colloids were prepared using a standard aqueous emulsion polymerization technique. The copper catalyzed click transformations with the azide-terminated carbazole (AC) were done in water. Moieties which incorporate carbazolyl groups are blue emitters, which allows for spectroscopic measurement of their constitution [31, 32]. The biotransformation of the small molecule 9H-carbazole (CAR) by P. resinovorans CA10 results in non-fluorescing intermediate metabolites which include 2′-aminobiphenyl-2,3-diol (ABP), 2-amino-benzoic acid (ABA), and pyrocatechol (PC)[18, 33-35]. We utilized these characteristics to monitor the degradation of carbazole by P. resinovorans CA10 (See, FIG. 9) and to analyze the interaction of PA/AC particles with P. resinovorans CA10 lysate.

The PA/AC particles underwent a 48 hour click transformation, which results in a surface grafting density of ca. 3.5 AC groups/nm² and corresponds to a 100% coverage if the distance of a carbazole ring at its widest point (ca. 7 Å) can be assumed to define the diameter of a cylinder enclosing the moiety and attached to the PA surface[36]; each particle (diameter=83±12 nm) has then ca. 76k AC moieties. The modified particles underwent multiple water washes with centrifugation to remove any remaining reactants or copper catalyst. The cleaned PA/AC colloids were then incubated at 5° C. for 1 hour with the lysate of P. resinovorans CA10 (cf. FIG. 1b).

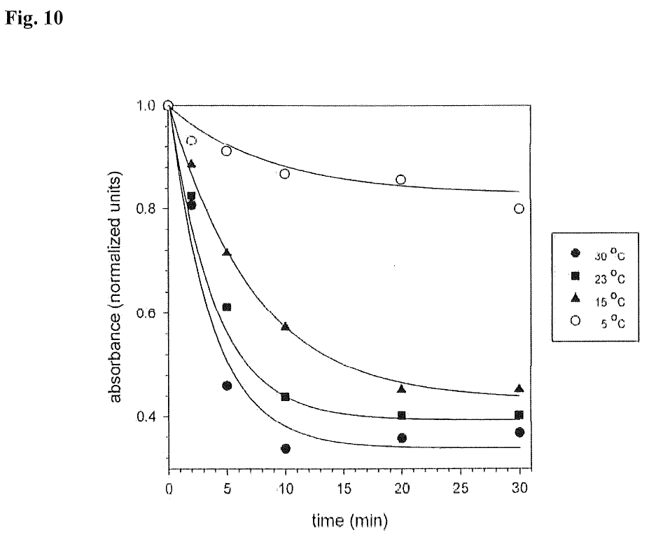

Differing species of carbazole degraders (such as P. resinovorans CA10) all appear to follow a similar carbazole degradation pathway that begins with the oxidative cleavage of the heterocyclic nitrogen ring of carbazole, catalyzed by CARDO[33]. This reaction results in the cleavage of one of the two carbon nitrogen bonds; however, subsequent biodegradation of carbazole by all characterized cultures involves the degradation of one of the aromatic rings, meaning these degraders also contain a carbon-carbon cleavage capabilities [37]. For example, P. resinovorans CA10 has the capability to utilize carbazole as its sole source of carbon, nitrogen and energy, but the CARDO, present in all carbazole-degrading bacteria, also catalyzes diverse oxygenations of a variety of aromatic compounds, e.g. dioxin and fluorene, at reduced efficiency[33]. These enzymes typically consist of two or three components that comprise an electron-transfer chain that mobilizes electrons from NADH or NADPH via avin and the [2Fe-2S] redox center of the dioxygenating activation site. The activation of this catalytic chain can be slowed by temperature reduction. This was verified by an enzyme activity assay measuring 9H-carbazole degradation with purified CARDO at various temperatures (See, FIG. 10). Thus, low temperature incubation allows for the immobilization of the enzyme onto the particles through the bioaffinity of CARDO for the attached carbazole but reduces the kinetic rate in which this enzyme catalyzes the biotransformation [11].

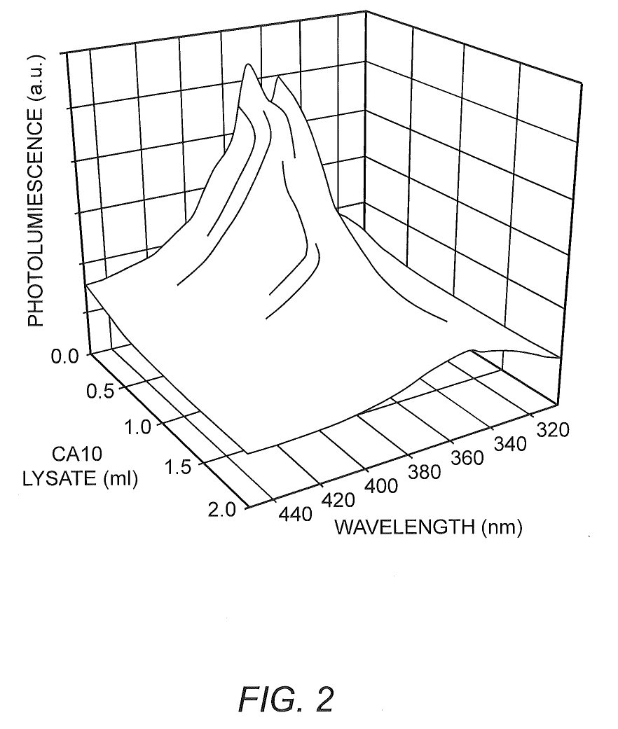

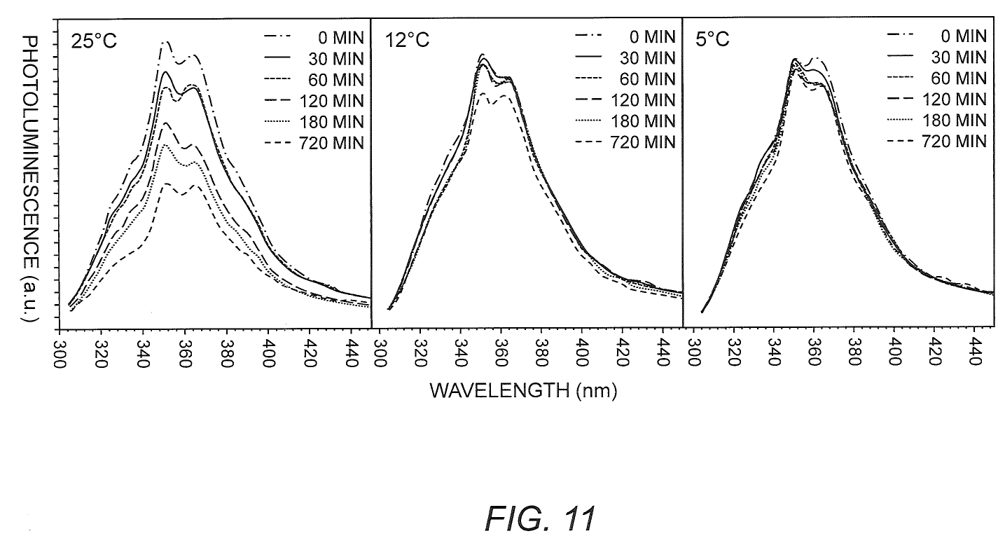

First, the enzymatic degradation of the attached carbazole was performed at 30° C. FIG. 2 presents the change in the photoluminescence (PL) spectra of PA/AC particles after a 12 hour incubation with various concentrations of P. resinovorans CA10 lysate. Initially, the spectral characteristics of the modified particles exhibit peaks at ca. 350 nm and 366 nm which are attributed to the monomeric emission of the carbazole rings. In addition, the particles exhibit two additional peaks centered at 405 nm and 430 nm and are routinely attributed to excimer emission stemming from carbazole ring dimmers [38, 39]. The appearance of these lower energy peaks in the PL spectra suggest that the carbazolyl groups are in close proximity and can energetically couple. When the particles are incubated at a ratio less than 6.12×10⁹ particles:1 μg P. resinovorans CA10 lysate, the PL signature is completely destroyed and replaced by a broad and weak peak centered at 360 nm. Like the degradation of 9H-carbazole by CARDO, this enzymatic degradation can be slowed by reducing the incubation temperature. At 5° C., significant AC degradation has slowed beyond 1 h (See, FIG. 11). We can then take advantage of the slowed reaction to extract immobilized enzymes.

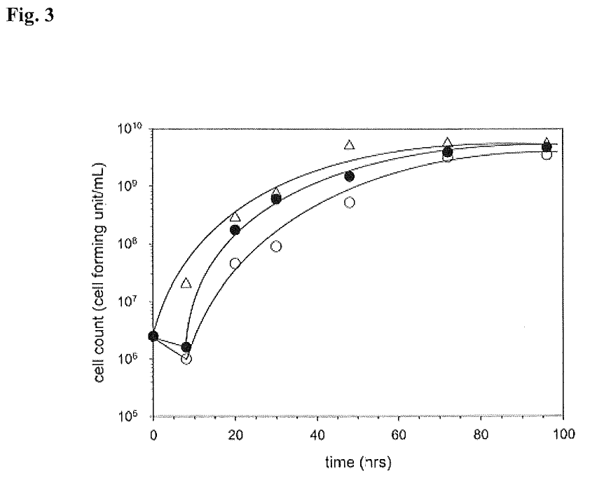

The bioavailability of the hydrophobic metabolites is also critical to understanding metabolic enzymes that bind to them[40]. Prior efforts have indicated that P. resinovorans CA10 can degrade the small molecule 9H-carbazole [18, 41, 42]. We show that the modification of this small molecule with an aliphatic chain attached to the nitrogen (9-(3-azidopropyl)-9H-carbazole) does not alter the ability of CA10 to employ it as a substrate. FIG. 3 presents the proliferation of P. resinovorans CA10 with both 9H-carbazole and PA/AC particle based media during a 96 hour incubation. The consistent growth between free carbazole and PA/AC shows the flexibility of CA10 to degrade carbazolyl moieties sequestered to particles. The growth curves show that attachment of metabolites to PA colloids did not hinder bioavailability or activity.

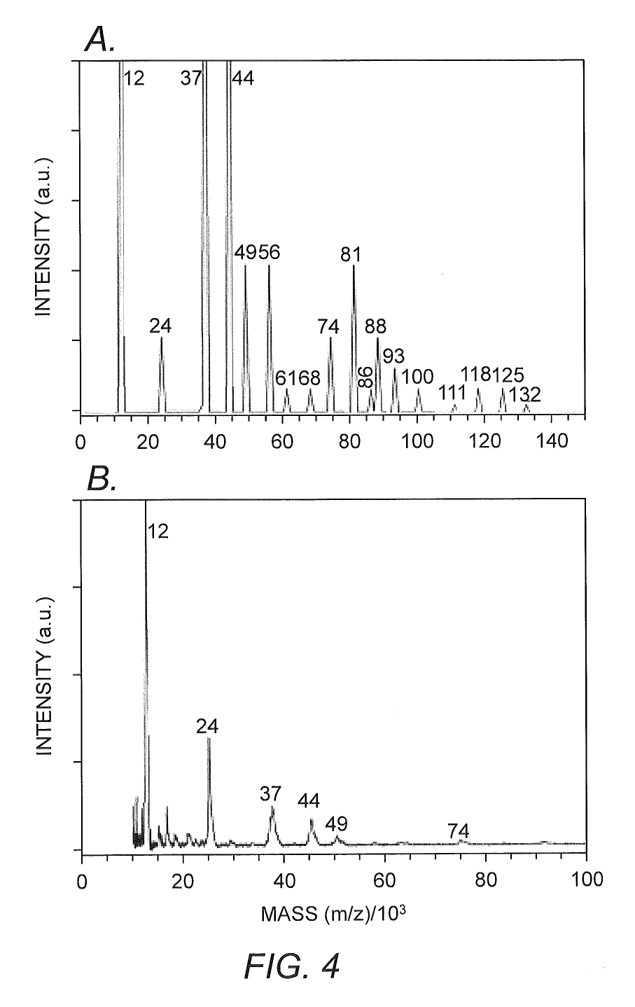

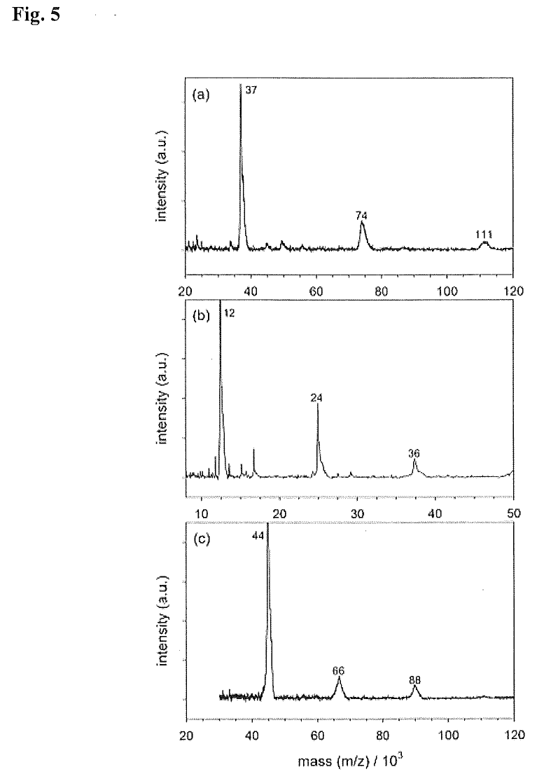

The low temperature incubation of the particles with the lysate of P. resinovorans CA10 allows for the immobilization of the protein on the particle (cf. FIG. 1b). Once immobilized, the particles can be centrifuged and effectively capture the enzymes, filtering them from non-specific proteins (cf. FIG. 1c). To assess the specificity of the immobilization on the particles, the centrifuged particles were washed with a mild NaCl solution to remove non-specifically bound proteins and then were subjected to matrix-assisted laser desorption/ionization (MALDI) time-of-flight (TOF) mass analysis in order to identify the sequestered enzymes. FIG. 4 presents the predicted mass spectrum of the neat CARDO protein constituents and the observed PA/AC particles with immobilized protein [1, 43]. CARDO has been identified as a multicomponent enzyme system which consists of three components: CARDO-O (terminal oxygenase), CARDO-F (ferredoxin), and CARDO-R. (ferredoxin reductase) [44]. The components CARDO-F (12-kDa monomer) and CARDO-R (37-kDa monomer) function as a ferredoxin and a ferredoxin reductase, respectively, to transport electrons from NADH to terminal oxygenase. The CARDO-O is a 132-kDa homotrimeric terminal oxygenase made up of 44-kDa monomeric units. The experimentally observed mass spectrum (cf. FIG. 4b) exhibits high intensity peaks at 12, 24, 37, and 44 kDa, as well as two lesser peaks at 49 and 74 kDa. These majority peaks are consistent with the predicted mass spectrum, while the peaks at masses over 74 kDa are in the noise level of the instrument. To further demonstrate that correlation between the observed and predicted mass spectrum, the component proteins of CARDO were purified employing traditional multistep affinity purification methods using a polyhistidine-tag/nickel pair and their mass spectrum acquired. FIG. 5 presents the MALDI mass spectrum of CARDO-O CARDO-F, and CARDO-R. All of the peaks observed in these component proteins are observed in FIG. 4b except for the masses greater than 74 kDa due to the signal to noise ratio in the spectrum.

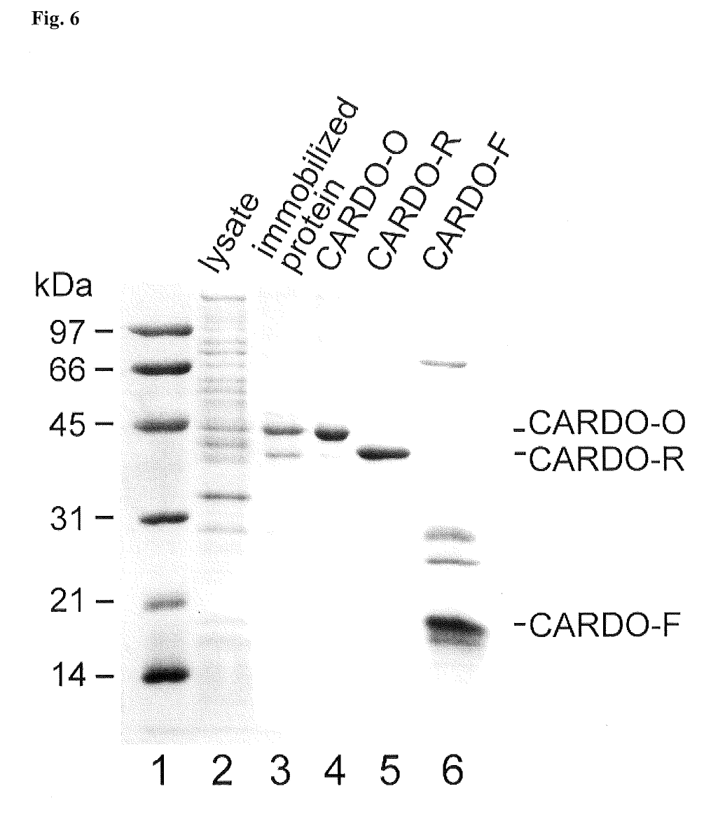

Sodium dodecyl sulfate polyacrylamide gel electrophoresis was employed in order to assess the molecular weights of the immobilized proteins and visually confirm the extraction of the CARDO components from whole-cell P. resinovorans CA10 lysate. In FIG. 6, the proteins immobilized on the PA/AC particles is presented in lane 3 while the raw lysate is presented in lane 2 (lane 1 is the molecular weight markers). The immobilized proteins produced two distinct bands corresponding to a molecular mass of 44 and 37 kDa. These molecular masses correspond to CARDO-O and CARDO-R respectively [44]. This identification was corroborated by comparison with the electrophoretic mobility of purified CARDO-O and CARDO-R as shown in lanes 4 and 5. The high intensity of the bands indicates that this methodology has advantages in the selective harvesting and concentrating of these proteins from the crude lysate in a single step. The purified CARDO-F protein (FIG. 6, lane 6) exhibits multiple bands and appears to run slower than its actual molecular weight, characteristics which have been presented in previous reports[44, 45]. Faint bands similar to the purified CARDO-F are present in the immobilized proteins. The presence of this protein can be verified by a bioactivity assay with the immobilized proteins because in the CARDO P. resinovorans CA10 system, CARDO-F is essential for electron transfer to CARDO-O and must be present for bioactivity[44].

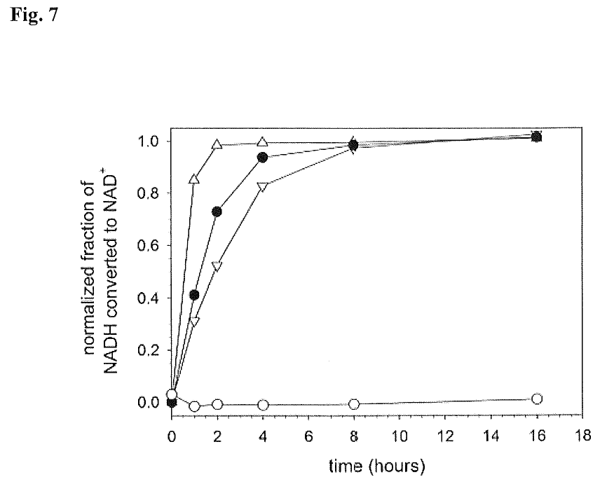

To assess the bioactivity of the proteins attached to the particles, a modified affinity assay was carried out in which the addition of NADH, FAD, and Fe²⁺ reconstituted the enzyme electron transport system and activity was promoted by the addition of carbazole and an increase in temperature to 30° C.[44]. FIG. 7 presents the measurement of activity with incubation time for these harvested protein as well as CA 10 lysate incubated with PA/AC particles, neat CA 10 lysate, and non-specific proteins.

The ability of PA/AC particles to harvest desired enzymes was assessed by the conversion of NADH to NAD⁺. This conversion was monitored through the loss of an absorption peak at 340 nm of the supernatant over a specified incubation period. Under all activity studies, the carbazole concentration was kept constant. As was expected, the neat lysate exhibited the fastest conversion, with the NADH oxidized to NAD⁺ within a 2 hour incubation period. This is due to the high protein content of the neat lysate relative to the substrate concentration. Similarly, the lysate incubated with the PA/AC particles exhibited a high level of NADH to NAD+ conversion, confirming the PA/AC's ability to trap and remove carbazole degrading enzymes. The proteins immobilized on the particles were released and capable of the biotransformation of carbazole as determined through the oxidation of NADH (cf. FIG. 1e). The degradation of carbazole by extracted proteins verifies the PA/AC particles capabilities to extract the entire CARDO complex, including CARDO-O, CARDO-R, and CARDO-F. Without each component of the enzyme, bioactivity could not be restored. Although, the activity of the proteins sequestered on the particles was similar to the neat lysate, it was reduced in rate due to the lower ratio of protein to substrate. In contrast, the non-specific proteins exhibited no activity towards the carbazole.

Clearly, the immobilization of the CARDO proteins on the particles still allows them to function as a carbazole degrader once removed from the particles. In the CARDO P. resinovorans CA10 system, an unrelated reductase can be substituted for CARDO-R and still maintain activity, but CARDO-F is indispensable for electron transfer to CARDO-O[44]. The observed activity of the sequestered proteins indicates that all three components have been harvested. In this effort, a model system was utilized to show the efficacy of synthesizing a “baited” nanoparticle to capture and recycle enzymes from lysate. Enzyme trapping and recycling was illustrated with the CARDO systems, an enzyme important in bioremediation and natural product synthesis. The enzymes were baited with an azide modified carbazolyl moiety attached to a PA nanoparticle. The bait products is well dispersed in water and buffers, a property that is independent of selected ligand, but a result of their attachment to PA particles. These results establish a universal model applicable to concentrating and extracting known substrate protein pairs, but it can be an invaluable tool in recognizing unknown protein-ligand affinities. Despite the widespread availability of genome sequences, according to the shear multitude of metabolites the selectivity of many metabolic enzymes are still veiled, this procedure goes a long way toward cultivating large banks of recyclable metabolic enzymes and probing enzyme selectivity.

### Fluorescence Measurement of 9H-Carbazole Degradation by Purified CARDO Complex

The purified enzymes CARDO-F, CARDO-O and CARDO-R were incubated in 500 μL buffer (50 mM Tris-HCl pH 7.5, 100 nmol/μL Mohr's Salt, 200 pmol/μL FAD+ and 100 nmol/μL NADH) at 30° C. All buffer cofactors were in excess as suggested by previous reports (J. W. Nam, et al. Purification and characterization of carbazole 1,9a-dioxygenase, a three-component dioxygenase system of Pseudomonas resinovorans strain CA10. Applied and Environmental Microbiology, 68(12):5882-5890, 2002). The reaction was started with the addition of 50 nmol/μL 9H-carbazole dissolved in DMSO. The sample was incubated in a water jacketed cuvette to maintain a constant temperature. Samples were gently stirred with a magnetic stir plate. The photoluminescence spectra were collected using a Jobin-Yvon Fluorolog 3-222 Tau spectrometer at λex=295 nm. FIG. 9 shows the loss of 9H-carbazole fluorescence during incubation with the CARDO complex.

### Temperature Dependence of CARDO Catalysis on 9H-Carbazole and PA/AC

Purified CARDO complex activity was monitored using a modified enzymatic assay previously described [H. Nojiri, et al. Structure of the terminal oxygenase component of angular dioxygenase, carbazole 1,9a-dioxygenase. Journal of Molecular Biology, 351(2):355-370, 2005.]. The purified enzymes CARDO-F, CARDO-O and CARDO-R were incubated in 20 μL Buffer D (25 mM Tris-HCl pH 7.5 and 1 mM NADH) containing 1 mM carbazole dissolved in DMSO at varying temperatures from 30° C. to 5° C. An aliquot was removed from the reaction at the indicated times and the absorbance of the reaction was determined with a NanoDrop spectrophotometer (Thermo Scientific) at 295 nm. At 5° C., the conversion of carbazole was significantly retarded as shown in FIG. 10.

### Temperature Dependence of CA10 Lysate Degradation on PA/AC

CA10 lysate interaction with PA/AC was monitored by fluorescence. In this experiment, a 1 mL CA10 lysate (5.6 μg/μL) and 100 μL PA/AC (3.43×10¹³ particles/mL) was incubated in a water jacketed cuvette to maintain a constant temperature. Samples were stirred with a magnetic stir plate. Temperature dependence was evaluated at 25° C., 12° C., and 5° C. Fluorescence measurements were made at t=0, 30, 60, 120, 180, and 720 min. The PL spectra were collected using a Jobin-Yvon Fluorolog 3-222 Tau spectrometer with λex=295 nm. FIG. 11 shows the fluorescence characterization of the degradation of PA/AC by CA10 lysate at different temperatures. There is ˜50% decrease in the 351 nm peak at 25° C., as compared to ˜13% at 12° C., and only ˜5% decrease at 5° C. over 12 h.

### Experimental Section

### Reagents and Solvents

All the commercial reagents were used without further purification. All the solvents were dried according to standard methods. Deionized water was obtained from a Nanopure System and exhibited a resistivity of ca. 10¹⁸ ohm⁻¹cm⁻¹.

### Characterization

¹H and ¹³C NMR spectra were recorded on JEOL ECX 300 spectrometers (300 MHz for proton and 76 MHz for carbon). Chemical shifts for protons are reported in parts per million downfield from tetramethylsilane and are referenced to residual protium in the NMR solvent (CDCl₃: δ 7.26 ppm, DMSO-d6: δ 2.50 ppm). Chemical shifts for carbons are reported in parts per million downfield from tetramethylsilane and are referenced to the carbon resonances of the solvent (CDCl₃: δ 77.16, DMSO-d6: δ 39.52 ppm). Electron impact (EI) (70 eV) ionization mass spectra were obtained using Shimadzu GC-17A mass spectrometer. LC/MS mass spectra were obtained using Finnigan LCQ spectrometer and HP 1100 (HPLC). Photoluminescence (PL) spectra were collected using a Jobin-Yvon Fluorolog 3-222 Tau spectrometer.

### Materials

### Synthesis of 9-(3-azidopropyl)-9H-carbazole (AC)

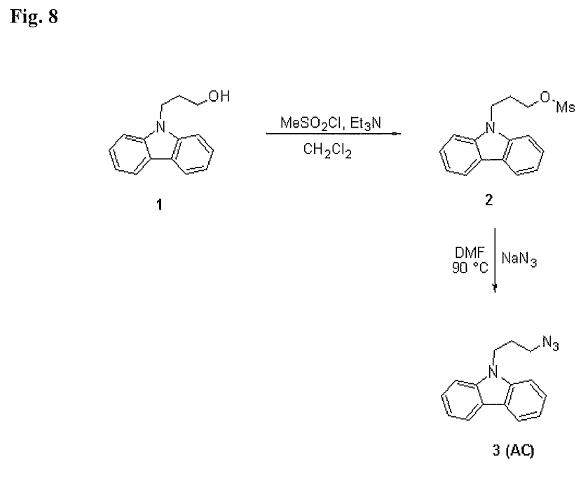

The reaction scheme for 9-(3-azidopropyl)-9H-carbazole (AC) is shown in FIG. 8.

### 3-(9H-Carbazol-9-yl)propyl methanesulfonate (2)

Methanesulfonyl chloride (0.84 g, 7.32 mmol) was added dropwise at room temperature to a stirred solution of 3-(9H-carbazol-9-yl)propan-1-ol (1.5 g, 6.66 mmol) (1) (synthesized according to Ref. [46]) and triethylamine (0.74 g, 7.32 mmol) in dichloromethane (25 mL). The solution was stirred for 8 hours and then washed with water two times. The organic layer was separated, dried with Na2SO4 and then filtered. The solvent was removed under reduced pressure to give the clear-yellow oil. Yield: 1.96 g (97%). ¹H NMR (CDCl₃) 2.36 (m, 2H, J 6.5, 5.9), 2.86 (s, 3H), 4.14 (t, 2H, J 5.9), 4.50 (t, 2H, J 6.5), 7.25 (m, 2H), 7.40-7.52 (m, 4H), 8.10 (d, 2H, J 7.9).

### 9-(3-Azidopropyl)-9H-carbazole (AC) (3)

A mixture of 3-(9H-carbazol-9-yl)propyl methanesulfonate (2) (1.96 g, 6.46 mmol) and sodium azide (0.46 g, 7.14 mmol) in dimethylformamide (25 mL) was heated and stirred at 90° C. for 4 hours. After cooling to room temperature, the mixture was quenched with water and extracted with dichloromethane. The organic solution was washed with water, dried with Na₂SO₄ and filtered. The solvent was removed under reduced pressure to give the clear-brown oil, which was purified by ash chromatography (10% ethyl acetate/hexane; Rf=0.4). A clear-yellow oil was obtained. Yield: 1.34 g (82%). ¹H NMR (CDCl₃) 2.13 (m, 2H, J 6.2), 3.30 (t, 2H, J 6.2), 4.42 (t, 2H, J 6.5), 7.24 (m, 2H), 7.41-7.50 (m, 4H), 8.10 (d, 2H, J 7.6). ¹³C NMR (CDCl₃, 75.6 MHz) δ 28.3, 39.8, 48.8, 108.6, 119.2, 120.6, 123.1, 126.0, 140.4. EI-Mass (m/z; rel. intensity %) 251 (M++1; 5), 250 (M+; 35), 194 (12), 180 (100), 167 (65), 152 (46), 139 (21).

### Preparation of the Baited Particles

Monodisperse poly(propargyl acrylate) (PA) particles were prepared using a modified emulsion polymerization procedure. The propargyl acrylate (PA) (4.6 ml) and divinylbenzene (DVB) (0.8 ml) were passed through a packed alumina column while all other materials were used as-received. A 500 mL three necked jacketed reactor was charged with 140 mL of deionized water and 0.08 g of sodium dodecyl sulfate (SDS, 99% Aldrich) was added and the solution was stirred for 1 h at 83° C. under a nitrogen atmosphere. The PA and DVB were mixed and slowly dropped into the reaction vessel. Once the addition of the PA:DVB mixture was completed, 0.2 mL of 3-alloxy-2-hydroxy-1-pro-panesulfonic acid sodium salt (COPS-1, 40 wt % soln. Aldrich) in 5 mL deionized water was added dropwise to the solution. After the COPS-1 was completely added, the solution was stirred for an additional 5 min before 0.16 g potassium persulfate (KPS, 99+% Aldrich), that was mixed with 5 mL deionized water, was added to the solution. The emulsion polymerization was carried out under a nitrogen atmosphere for at least 2 h. The resulting PA latex was dialyzed against deionized water for ca. 5 days at 60° C. using a dialysis bag with a molecular weight cut-off of 50,000. The dialyzed dispersion was then shaken with an excess of mixed bed ion-exchange resin (Bio-Rad Lab AG 501- X8, 20-50 mesh) to remove excess electrolyte. After the cleaning procedures, the particle diameter was measured to be 83±12 nm (average and standard deviation) with a Coulter N4Plus dynamic light scatter (DLS). Drying a known mass of the suspension in an oven at 90° C. overnight and then in a vacuum oven for 2 days, resulted in a particle density of 3.43×10¹³ particles/mL.

For a typical surface modification of the particles, for example, the grafting of AC onto the particles, 1 mL PA particles and 4.5 mg AC were added to a 2 mL deionized water. Solutions of 0.0644 g copper(II) sulfate (99.999% Aldrich) in 10 mL deionized water and 0.17 g sodium ascorbate (99% Aldrich) in 10 mL deionized water were made. Initially, 0.2 mL of the Cu2SO4 solution was added to the PA/AC solution, followed by 0.3 mL of the sodium ascorbate solution. The resulting mixture was maintained at a temperature of ca. 28° C. for 48 h. The resulting clicked particles were dialyzed against deionized water for ca. 3 days at 60_C using a dialysis bag with a molecular weight cut-off of 50,000.

Preparation of P. resinovorans CA10 Lysate

P. resinovorans CA10 was grown in minimal media M9 minus glucose at 30° C. for 48 hrs. The cells were harvested using a Beckman JLA 16.250 rotor at 10000×g at 4° C. The cell pellet (20 g) was resuspended in five volumes of Buffer A (20 mM K2HPO4 (pH 7.4), 0.5 mM DTT, 10% sucrose, 0.250 M KCl, protease inhibitors: pepstatin, leupeptin, chymostatin and aprotinin 5 μg/ml final concentration, 1 mM PMSF and 1 mM EDTA) and incubated with 1 mg/ml lysozyme at 4° C. The resuspended cells were sonicated and subjected to ultracentrifugation using a T-1270 Sorvall rotor for 45 mM at 100,000×g. The clarified supernatant was frozen in aliquots using liquid nitrogen and stored at −80° C. The total protein concentration was measured using Bradford's assay [47].

### Purification of CARDO Proteins

All the resins and chemicals were from GE healthcare and American Bioanalytical, respectively, unless otherwise mentioned.

### Expression of CARDO-F, CARDO-O and CARDO-R

Plasmids harboring genes for CARDO-F-(HIS)₆, CARDO-O-(HIS)₆ and CARDO-R-(HIS)₆ vectors were a kind gift from Hideaki Nojiri. Each plasmid was transformed separately in the BL21(DE3) Rosetta strain of Escherichia coli. The transformed bacterial cells were grown in 2×LB media (yeast extract 5 g/L, tryptone 10 g/L and NaCl 5 g/L) supplemented with kanamycin (50 μg/ml) at 37° C. to an OD of 0.8. Isopropyl-D-1-thiogalactopyranoside (IPTG) was added to the cultures (final concentration of 0.4 mM) and the culture was further incubated for 16 hrs. The cells were harvested by centrifugation at 6000 rpm at 16° C. for 10 mM in a Beckman 8.1000 rotor.

### Purification of CARDO-F, CARDO-O and CARDO-R

Lysate from bacterial cell pellets for each of CARDO-F, CARDO-O and CARDO-R was separately prepared using the same protocol at 4° C. A 30 g cell pellet of each bacterial culture was resuspended separately in 150 ml Buffer A and incubated at 4° C. for 30 min in the presence of lysozyme (1 mg/mL) followed by sonication. Each individual lysate was centrifuged at 40,000 rpm in a Beckman Ti-45 rotor for 1 hr at 4° C. The supernatant from each lysate was further subjected to affinity and conventional column chromatography as described below.

### CARDO-F Purification

The supernatant from the CARDO-F lysate was incubated with Ni-NTA sepharose (GE Healthcare) for 1 hr. The supernatant-Ni-NTA slurry was collected and poured into a column (0.7 cm inner diameter×0.5 height). The Ni-NTA column was washed with Buffer B (20 mM K2HPO4 pH 7.4, 300 mM KCl, 10% glycerol, and 1 mM EDTA) followed by elution of CARDO-F with Buffer B containing 500 mM imidazole. Peak fractions were diluted to match conductivity of Buffer C (20 mM K2HPO4 pH 7.4, 10% glycerol, and 1 mM EDTA) containing 100 mM KCl and loaded on a 1 mL Source 15Q column (GE Healthcare). The bound protein was fractionated using Buffer C containing 100 mM-800 mM KCl. The peak fractions containing the protein (˜700 mM KCl) were pooled, diluted to match conductivity of Buffer C containing 100 mM KCl and loaded onto a 1 mL Source 15S column (GE Healthcare). The bound protein was fractionated using Buffer C containing 100 mM 800 mM KCl. The peak fractions (˜150 mM KCl) containing CARDO-F were pooled, concentrated and stored at −80° C.

### CARDO-O Purification

The supernatant containing CARDO-O was subjected to Ni-NTA affinity chromatography as described for CARDO-F. The eluate from the Ni-NTA column was diluted to match conductivity of Buffer C containing 100 mM KCl then loaded on a 1 mL Source 15Q column. The bound protein was fractionated as described for CARDO-F. Peak fractions containing the CARDO-O (˜360 mM KCl) were pooled, diluted to match conductivity of Buffer C containing 100 mM KCl and loaded onto a 1 mL Source 15S column. The bound protein was fractionated as described for CARDO-F. The peak fractions (˜100 mM KCL) containing CARDO-O were pooled, concentrated and stored at −80° C.

### CARDO-R Purification

The supernatant containing CARDO-R was subjected to Ni-NTA affinity chromatography as described for CARDO-F. The eluate from the Ni-NTA column was diluted to match conductivity of Buffer C containing 100 mM KCl then loaded on a 1 mL Source 15Q column. The bound protein was fractionated as described for CARDO-F. Peak fractions containing the CARDO-R (˜400 mM KCl) were pooled, diluted to match conductivity of Buffer C containing 100 mM KCl and loaded onto a 1 mL Source 15S column. The bound protein was fractionated as described for CARDO-F. The peak fractions (˜100 mM KCL) containing CARDO-R were pooled, concentrated and stored at −80° C.

### Denaturing Polyacrylamide Gel Electrophoresis

The protein samples (whole cell lysate, 5 μg; purified lysate, 1 μg; CARDO-O, 1 μg; CARDO-R, 1.5 μg; and CARDO-F, 2 μg) were loaded on a 12% SDS-polyacrylamide gel and subjected to electrophoresis for 50 min at 200V. The gel was stained using Commassie Brilliant Blue. The image was taken using Gel-Doc (Bio-Rad).

### Enzyme Trapping and Affinity Activity Assay

The enzyme trapping and affinity of the bound proteins were assessed through the following procedures. Initially, 100 μL PA/AC particles in an aqueous buffer (3.43×1013/cm3 and (100 μL in 0.8 mL water)) were added to 100 μL neat lysate of CA 10 and incubated at 5° C. for 1 hour. This solution of particles and lysate was centrifuged (10,000×g, 5° C., 10 min.) and the supernatant was decanted. The particles were washed with 1 mL of a 100 mM NaCl solution and the tube was inverted 10 times followed by incubation for 30 min at 5° C. After the incubation, the particles were centrifuged (10,000×g, 5° C., 10 min) (PA/AC particles with bound proteins) and the salt solution decanted. To assess the activity of the various components (PA/AC particles with bound proteins, incubated lysate, non-specific proteins, and neat lysate), each was individually added to an aqueous buffer in which 5 μL of a 10 nmol carbazole/DMSO solution was added. To initiate bioactivity, 1 nmol flavin adenine dinucleotide (FAD), 100 nmol ammonium iron(II) sulfate, and 100 nmol NADH, were added, resulting in a total buffer volume of 1 mL, and the temperature raised to 30° C. All cofactors were added in excess. After either 30, 60, 120, 240, 320, or 960 min., the temperature of the samples was lowered to 5° C., the tubes centrifuged (10,000×g, 5° C., 10 min), and the supernatant decanted and the oxidation of NADH to NAD+ assessed through the change in absorption of the supernatant at 340 nm.

### MALDI/TOF Measurements

All samples were analyzed in a saturated 3,5-dimethoxy-4-hydroxycinnaminic acid solubilized in 1:1 water:acetonitrile, 0.1% TFA. A sandwich method of 1 μL matrix, followed by 1 μL acid solubilized sample, capped with 1 μL matrix was prepared on the plate. A desalting step of 1 μL water was utilized for all samples. The samples were analyzed with the Bruker OmniFlex III.

### REFERENCES

[1] Niels Jonker, Jeroen Kool, Hubertus Irth, and Wilfried M. A. Niessen. Recent developments in protein-ligand affinity mass spectrometry. Analytical and Bioanalytical Chemistry, 399(8):2669-2681, 2011.
[2] Brett Lomenick, Richard W. Olsen, and Jing Huang. Identification of direct protein targets of small molecules. Acs Chemical Biology, 6(1):34-46, 2011.
[3] Cuatreca. P, M. Wilchek, and C. B. Anfinsen. Selective enzyme purification by affinity chromatography. Proceedings of the National Academy of Sciences of the United States of America, 61(2):636-649, 1968.
[4] Andrew K. Johnson, Anna M. Zawadzka, Lee A. Deobald, Ronald L. Crawford, and Andrzej J. Paszczynski. Novel method for immobilization of enzymes to magnetic nanoparticles. Journal of Nanoparticle Research, 10(6):1009-1025, 2008.
[5] Amirali Popat, Sandy Budi Hartono, Frances Stater, Jian Liu, Shi Zhang Qiao, and Gao Qing Lu. Mesoporous silica nanoparticles for bioadsorption, enzyme immobilisation, and delivery carriers. Nanoscale, 3(7):2801-2818, 2011.
[6] J. Kim, J. Lee, H. B. Na, B. C. Kim, J. K. Youn, J. H. Kwak, K. Moon, E. Lee, J. Park, A. Dohnalkova, H. G. Park, M. B. Gu, H. N. Chang, J. W. Grate, and T. Hyeon. A magnetically separable, highly stable enzyme system based on nanocomposites of enzymes and magnetic nanoparticles shipped in hierarchically ordered, mesocellular, mesoporous silica. Small, 1(12):1203-1207, 2005.
[7] B. M. Brena, J. Lidholm, F. Batista-Viera, and J. Carlsson. Selective removal of enzymes from substrate and products. an alternative to immobilization for enzymes acting on macromolecular or solid substrates. Applied Biochemistry and Biotechnology, 75(2-3):323-341, 1998.
[8] Caterina Longo, Guido Gambara, Virginia Espina, Alessandra Luchini, Barney Bishop, Alexis S. Patanarut, III Petricoin, Emanuel F., Francesca Beretti, Barbara Ferrari, Enrico Garaci, Anto De Pol, Giovanni Pellacani, and Lance A. Liotta. A novel biomarker harvesting nanotechnology identifies bak as a candidate melanoma biomarker in serum. Experimental Dermatology, 20(1):29-34, 2011.
[9] Caterina Longo, Alexis Patanarut, Tony George, Barney Bishop, Weidong Zhou, Claudia Fredolini, Mark M. Ross, Virginia Espina, Giovanni Pellacani, III Petricoin, Emanuel F., Lance A. Liotta, and Alessandra Luchini. Core-shell hydrogel particles harvest, concentrate and preserve labile low abundance biomarkers. Plos One, 4(3), 2009.
[10] Alessandra Luchini, Caterina Longo, Virginia Espina, III Petricoin, Emanuel F., and Lance A. Liotta. Nanoparticle technology: Addressing the fundamental roadblocks to protein biomarker discovery. Journal of Materials Chemistry, 19(29):5071-5077, 2009.
[11] J. Kalisiak, S. A. Trauger, E. Kalisiak, H. Morita, V. V. Fokin, M. W. W. Adams, K. B. Sharpless, and G. Siuzdak. Identification of a new endogenous metabolite and the characterization of its protein interactions through an immobilization approach. Journal of the American Chemical Society, 131(1):378-386, 2009.
[12] M. J. van derWerf, R. H. Jellema, and T. Hankemeier. Microbial metabolomics: replacing trial-and-error by the unbiased selection and ranking of targets. Journal of Industrial Microbiology & Biotechnology, 32(6):234-252, 2005.
[13] Natsumi Saito, Yoshiaki Ohashi, Tomoyoshi Soga, and Masaru Tomita. Unveiling cellular biochemical reactions via metabolomics-driven approaches. Current Opinion in Microbiology, 13(3):358-362, 2010.
[14] Andrew D. Patterson, Frank J. Gonzalez, and Jeffrey R. Idle. Xenobiotic metabolism: A view through the metabolometer. Chemical Research in Toxicology, 23(5):851-860, 2010.
[15] W. B. Dunn, N. J. C. Bailey, and H. E. Johnson. Measuring the metabolome: current analytical technologies. Analyst, 130(5):606-625, 2005.
[16] Chirayu Desai, Hilor Pathak, and Datta Madamwar. Advances in molecular and “-omics” technologies to gauge microbial communities and bioremediation at xenobiotic/anthropogen contaminated sites. Bioresource Technology, 101(6):1558-1569, 2010.
[17] R. Kaddurah-Daouk, B. Kristal, and R. Weinshilboum. Metabolomics: A global biochemical approach to drug response and disease. Annual Review of Pharmacology and Toxicology, 48:653-683, 2008.
[18] N. Ouchiyama, Y. Zhang, T. Omori, and T. Kodama. Biodegradation of carbazole by Pseudomonas spp CA06 and CA10. Bioscience Biotechnology and Biochemistry, 57(3):455-460, 1993.
[19] S. K. Ahuja, G. M. Ferreira, and A. R. Moreira. Utilization of enzymes for environmental applications. Critical Reviews in Biotechnology, 24(2-3):125-154, 2004.
[20] J. S. Seo, Y. S. Keum, and Q. X. Li. Bacterial degradation of aromatic compounds. International Journal of Environmental Research and Public Health, 6(1):278-309, 2009.
[21] X. Wang, Z. H. Gai, B. Yu, J. H. Feng, C. Y. Xu, Y. Yuan, Z. X. Lin, and P. Xu. Degradation of carbazole by microbial cells immobilized in magnetic gellan gum gel beads. Applied and Environmental Microbiology, 73(20):6421-6428, 2007.
[22] A. L. Larentis, H. C. C. Sampaio, C. C. Carneiro, O. B. Martins, and T. L. M. Alves. Evaluation of growth, carbazole biodegradation and anthranilic acid production by Pseudomonas stutzeri. Brazilian Journal of Chemical Engineering, 28(1):37-44, 2011.
[23] D. Waldau, A. Mikolasch, M. Lalk, and F. Schauer. Derivatization of bioactive carbazoles by the biphenyl-degrading bacterium ralstonia sp strain sbug 290. Applied Microbiology and Biotechnology, 83(1):67-75, 2009.
[24] D. Waldau, K. Methling, A. Mikolasch, and F. Schauer. Characterization of new oxidation products of 9h-carbazole and structure related compounds by biphenyl-utilizing bacteria. Applied Microbiology and Biotechnology, 81(6):1023-1031, 2009.
[25] H. Habe, K. Ide, M. Yotsumoto, H. Tsuji, H. Hirano, J. Widada, T. Yoshida, H. Nojiri, and T. Omori. Preliminary examinations for applying a carbazole-degrader, Pseudomonas sp strain CA10, to dioxin-contaminated soil remediation. Applied Microbiology and Biotechnology, 56(5-6):788-795, 2001.
[26] P. Rungta, Y. P. Bandera, V. Tsyalkovsky, and S. H. Foulger. Designing fluoroprobes through forster resonance energy transfer: Surface modification of nanoparticles through “click” chemistry. Soft Matter, 6:6083-6095, 2010.
[27] H. C. Kolb, M. G. Finn, and K. B. Sharpless. Click chemistry: Diverse chemical function from a few good reactions. Angewandte Chemie-International Edition, 40(11):2004-2021, 2001.
[28] C. J. Hawker and K. L. Wooley. The convergence of synthetic organic and polymer chemistries. Science, 309(5738):1200-1205, 2005.
[29] E. Lallana, E. Fernandez-Megia, and R. Riguera. Surpassing the use of copper in the click functionalization of polymeric nanostructures: A strain-promoted approach. Journal of the American Chemical Society, 131(16):5748-5750, 2009.
[30] V. D. Bock, H. Hiemstra, and J. H. van Maarseveen. Cu-1-catalyzed alkyne-azide “click” cycloadditions from a mechanistic and synthetic perspective. European Journal of Organic Chemistry, 1(1):51-68, 2006.
[31] D. D Evano_, Jr., J. R. Lawrence, C. E. Huebner, J. M. Houchins, B. J. Stevenson, A. L. Foguth, J. B. Carroll, and S. H. Foulger. Copolymers of 2-(9h-carbazol-9-yl)ethyl 2-methylacrylate and 4-[5-(4-tert-butylphenyl)-1,3,4-oxadiazol-2-yl]phenyl 2-methylacrylate: Correlating hole drift mobility and electronic structure calculations with electroluminescence. ACS Applied Materials & Interfaces, 1:875-881, 2009.
[32] D. D Evanoff, Jr., J. B. Carroll, R. D. Roeder, Z. J. Hunt, J. R. Lawrence, and S. H. Foulger. Poly(methyl methacrylate) copolymers containing pendant carbazole and oxadiazole moieties for applications in single-layer organic light emitting devices. Journal of Polymer Science Part A-Polymer Chemistry, 46(23):7882-7897, 2008.
[33] H. Nojiri, J. W. Nam, M. Kosaka, K. I. Morii, T. Takemura, K. Furihata, H. Yamane, and T. Omori. Diverse oxygenations catalyzed by carbazole 1,9a-dioxygenase from Pseudomonas sp strain CA10. Journal of Bacteriology, 181(10):3105-3113, 1999.
[34] H. Nojiri, H. Sekiguchi, K. Maeda, M. Urata, S. I. Nakai, T. Yoshida, H. Habe, and T. Omori. Genetic characterization and evolutionary implications of a car gene cluster in the carbazole degrader Pseudomonas sp strain CA10. Journal of Bacteriology, 183(12):3663-3679, 2001.
[35] H. Nojiri and T. Omori. Molecular bases of aerobic bacterial degradation of dioxins: Involvement of angular dioxygenation. Bioscience Biotechnology and Biochemistry, 66(10):2001-2016, 2002.
[36] A. Voronov and O. Shafranska. Synthesis of chemically grafted polystyrene “brushes” and their influence on the dewetting in thin polystyrene films. Langmuir, 18(11):4471-4477, 2002.
[37] H. Nojiri, H. Habe, and T. Omori. Bacterial degradation of aromatic compounds via angular dioxygenation. Journal of General and Applied Microbiology, 47(6):279-305, 2001.
[38] W. Klopffer. Transfer of electronic excitation energy in polyvinyl carbazole. J. Chem. Phys., 50(6):2337{2343, 1969.
[39] G. E. Johnson. Intramolecular excimer formation in carbazole double molecules. Journal of Chemical Physics, 61(8):3002{3008, 1974.
[40] W. Tungittiplakorn, C. Cohen, and L. W. Lion. Engineered polymeric nanoparticles for bioremediation of hydrophobic contaminants. Environmental Science and Technology, 39(5):1354-1358, 2005.
[41] L. Li, P. Xu, and H. D. Blankespoor. Degradation of carbazole in the presence of non-aqueous phase liquids by Pseudomonas sp. Biotechnology Letters, 26(7):581-584, 2004.
[42] L. Li, Q. G. Li, F. L. Li, Q. Shi, B. Yu, F. R. Liu, and P. Xu. Degradation of carbazole and its derivatives by a Pseudomonas sp. Applied Microbiology and Biotechnology, 73(4):941-948, 2006.
[43] J. O. Lay. MALDI-TOF mass spectrometry of bacteria. Mass Spectrometry Reviews, 20(4):172-194, 2001.
[44] J. W. Nam, H. Nojiri, H. Noguchi, H. Uchimura, T. Yoshida, H. Habe, H. Yamane, and T. Omori. Purification and characterization of carbazole 1,9a-dioxygenase, a three-component dioxygenase system of Pseudomonas resinovorans strain CA10. Applied and Environmental Microbiology, 68(12):5882-5890, 2002.
[45] Y. Ashikawa, Z. Fujimoto, H. Noguchi, H. Habe, T. Omori, H. Yamane, and H. Nojiri. Crystallization and preliminary x-ray diffraction analysis of the electron-transfer complex between the terminal oxygenase component and ferredoxin in the rieske non-haem iron oxygenase system carbazole 1,9a-dioxygenase. Acta Crystallogr Sect F Struct Biol Cryst Commun, 61(Pt 6):577-80, 2005.
[46] J. Guan, D. E. Kyle, L. Gerena, Q. A. Zhang, W. K. Milhous, and A. J. Lin. Design, synthesis, and evaluation of new chemosensitizers in multi-drug-resistant plasmodium falciparum. Journal of Medicinal Chemistry, 45(13):2741-2748, 2002.
[47] M. M. Bradford. Rapid and sensitive method for quantitation of microgram quantities of protein utilizing principle of protein-dye binding. Analytical Biochemistry, 72(1-2):248-254, 1976.
[48] H. Nojiri, Y. Ashikawa, H. Noguchi, J. W. Nam, M. Urata, Z. Fujimoto, H. Uchimura, T. Terada, S, Nakamura, K. Shimizu, T. Yoshida, H. Habe, and T. Omori. Structure of the terminal oxygenase component of angular dioxygenase, carbazole 1,9a-dioxygenase. Journal of Molecular Biology, 351(2):355-370, 2005.

### Example 2

Sub-100 nm sized colloidal particles that are functionalized with multiple moieties have the potential to combine imaging, early detection, prevention, and the treatment of cancer with a single type of colloidal “nanodevice.”[1-5] Specifically, the design of a nanodevice that exhibits a cancer cell activated near-infrared fluorescence, which is coupled with a photodynamic response, is of particular interest. Photodynamic therapy (PDT) is a relatively new medical technology for the treatment of cancer that requires a photosensitizer and oxygen to be in the proximity of the afflicted tissue. [6,7] The photo-excitation of the photosensitizer results in the promotion from the ground singlet state (SO) to an excited singlet state (S1) with some excited singlets undergoing inter-system crossing to a longer-lived excited triplet state (T1). Oxygen resident in tissue has a ground triplet state and energy transferred from the photosensitizer to the oxygen can result in the formation of the highly cytotoxic singlet oxygen (¹O₂), resulting in destruction of the afflicted tissue. Tissue damage is localized due to the short lifetime of singlet oxygen in biological systems (<0.04 ns) and its corresponding short radius of action (<0.02 nm). [8]

A number of photosensitizers have been developed for commercial use in PDT, though there is still a need for systems that exhibit absorption of light in the infrared spectrum (NIR), which provides a maximal penetration of light into tissue. Indocyanine green (ICG) is an amphiphilic carbocyanine dye that exhibits absorption at ca. 780 nm and an emission maxima at ca. 820 nm. ICG exhibits very low toxicity effects to humans [10,11]. [14-16] The yield of triplet formation of free ICG through S1-T1 intersystem-crossing is 14% in water and 11% in an aqueous albumin solution.[17] Nonetheless, ICG has many of the shortcomings associated with organic dye molecules. One of the major challenges in its in vivo application is its low fluorescence quantum yield[19] and non-specific quenching.[20-23] In addition, free ICG will bind to proteins [24] which leads to aggregation and subsequent elimination from the body. One approach to remedy this shortcoming is the inclusion of the chromophores inside colloidal particles [25-27] and results in an extension of circulation half-life and enhanced in vivo stability relative to the free fluoroprobe molecules.[26] Specifically with regard to ICG, a number of researchers have employed a doped particulate approach to address the intrinsic issues of ICG degradation and rapid blood clearance.[27-31] Although all of these approaches have utilized an encapsulation approach that affords a static environment to the ICG and reduces environmental degradation, encapsulation prevents both (i) the chromophore from being spatially proximal to resident oxygen in afflicted tissue and (ii) the dye from participating in advantageous host/guest assemblies.

In the current effort, ICG and poly(ethylene glycol) (PEG) of various molecular weights were modified with attachment of a terminal azide and then attached to poly(propargyl acrylate) (PA) colloids through a copper catalyzed azide/alkyne cycloaddition (CuAAC) performed in water. The placement of ICG onto the surface of the particles allows for the chromophore to complex with proteins that resulted in the alteration and enhancement of the emission of the dye. In addition, the inclusion of PEG with ICG onto the particle surface resulted in a synergistic enhancement of the fluorescence intensity, with PEGs of increasing molecular weight amplifying the response. The surface attachment of ICG and its availability to be spatially adjacent to molecular oxygen when the particles are dispersed in tissue, coupled with protein enhanced fluorescence, may make these particles a valuable resource in PDT.[37]

### Results and Discussion

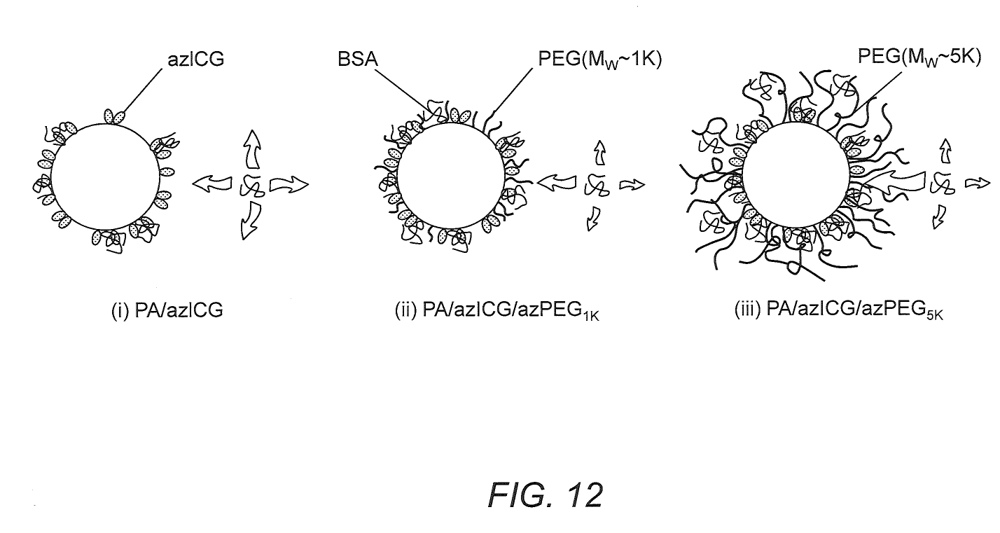

A schematic of the three particle-based system studied in this effort is presented in FIG. 12. The PA colloids were prepared using a standard aqueous emulsion polymerization technique with sodium dodecyl sulfate as the surfactant, potassium persulfate as the initiator, and divinyl benzene as a crosslinker, resulting in spheres of diameter of 73±7 nm (mean and standard deviation). To functionalize the surface of the particles, a multiple step “click” reaction was performed to produce PA particles that had both ICG and PEG on their surface. An azide-modified indocyanine green (azICG) was attached to the PA particles through a CuAAC (“click” transformation) performed in water. To attach the chromophores to the particles, the azICG was initially clicked onto the particles for 10 min and then the reaction was stopped by the removal of unreacted azICG, sodium ascorbate, and Cu(II)SO4 through a repeated particle washing procedure consisting of centrifugation and redispersement in methanol. The cleaned PA/azICG particles were subsequently utilized in a secondary click transformation with azide-modified PEG chains with molecular weights of 1,000 (azPEG1K) or 5,000 (azPEG5K) that was allowed to run for 24 hours and then washed to remove unreacted species; these particles are referred to as PA/azICG/azPEG1K and PA/azICG/azPEG5K, respectively.

Emission of azICG

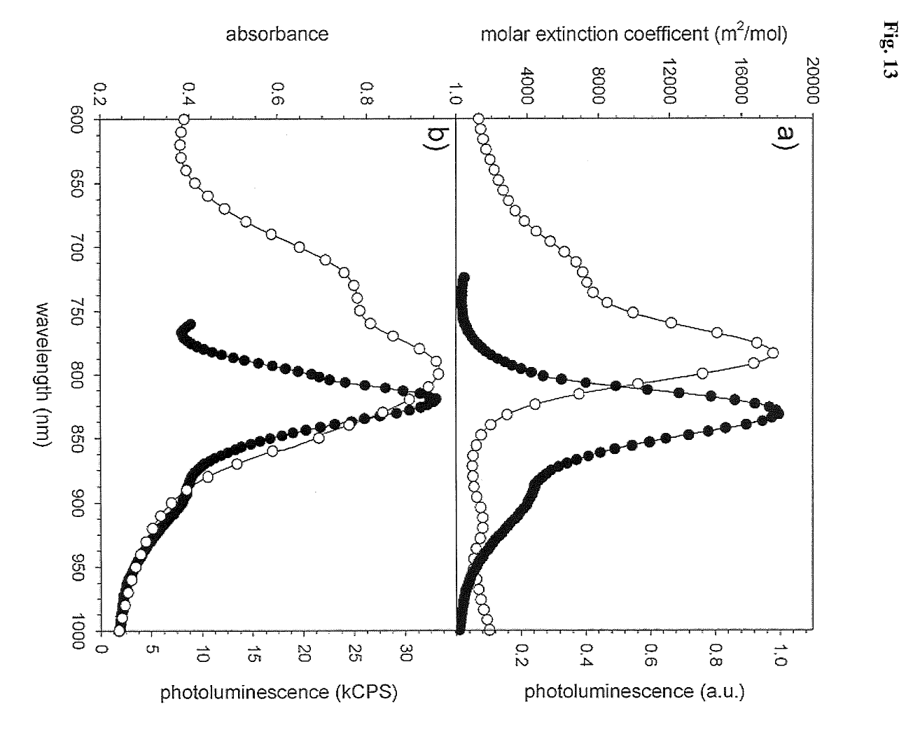

The emission characteristics of the azide-functionalized ICG are similar to ICG when dispersed in methanol. FIG. 13a presents the molar extinction coefficient and photoluminescence of the free azide-functionalized indocyanine green (azICG) dispersed in methanol. In this solvent, azICG has a peak absorption maximum at 785 nm, while the corresponding emission peak is at 830 nm, for a relatively small Stokes shift of 45 nm. The symmetry for the absorption and emission spectra is evident, though the absorption exhibits a small peak at 915 nm. This lower energy absorption is often seen in concentrated aqueous solutions of ICG after the formation of J-aggregates; [20, 38-41] the appearance of this peak in the freshly prepared dilute methanol solution of azICG is surprising and may suggest a higher self-affinity with the substitution of the sodium salt for the azide. The relative fluorescence quantum yield in methanol for azICG was φ=0.044±0.004, while the unfunctionalized ICG had a quantum yield φ=0.036±0.002, which suggests there is little effect in the emission characteristics of ICG with the addition of the azide moiety.

In comparison, FIG. 13b presents the absorption and photoluminescence spectra of PA particles after they have been modified with the attachment of azICG to their surface (PA/azICG particles) and dispersed in methanol. The absorption spectra of the PA/azICG particles indicate an absorption maximum that is at a wavelength of ca. 800 nm, a 15 nm bathochromic shift from the free dye. It is well known that ICG exhibits a molar extinction coefficient that is both concentration and solvent dependent. [38] Previous studies on free ICG have indicated that there is a strong affinity of the dye to methanol, which results in a reduction of the probability of dimer formation, and only at high dye concentrations does the inter-dye separation become small and closely spaced pairs and larger aggregates are formed. [20] Establishing the molar extinction coefficient in the dilute regime for the free azICG in methanol (cf. FIG. 13) can allow for the estimation of the number of chromophores attached to the particles. Following this approach, the PA/azICG particles had a grafting density of 1.84±0.50 ICG·nm⁻² when analyzed over the wavelength range of 700-800 nm. This grafting density would result in each azICG being statistically ca. 8 Å away from its nearest azICG neighbor. Similarly, elemental (combustion) analysis of the PA/azICG particles resulted in a grafting density of 1.5 ICG·nm⁻² with an inter-azICG spacing of ca. 9 Å. Even though the azICG is attached to the particle surface through a short aliphatic spacer and triazole ring, the large dimensions of the planar azICG, which are approximately 25 Å by 12 Å, would suggest that the molecules are packed relatively densely on the surface of the particles.

FIG. 13b presents the photoluminescence of the PA/azICG particles and indicates that the emission peak is at a wavelength of 820 nm, a 10 nm hypsochromic shift from the free azICG, with a resulting Stokes shift for the surface attached dyes of 20 nm. The relative fluorescence quantum yield for the PA/azICG particles was φ=0.017. As indicated earlier, the free azICG exhibited a quantum yield of φ=0.044 and the observed quantum yield for the surface-attached azICG moieties indicate that attaching the chromophores to the particles does reduce the quantum efficiency when the modified particles are dispersed in methanol. Particles may act as quenching centers of fluorescence for chromophores that are adsorbed onto their surface since (i) the planar surface offers a constrained two-dimensional region on which the chromophores can dimerize [42] and (ii) a non-radiative energy transfer can occur from the excited molecules to the particle,[20] though recent studies have indicated that dye-doped particles result in an optical system that underestimates the quantum efficiency of the dye using established procedures. [43] Nonetheless, dispersing the PEGylated PA/azICG particles (both with azPEG1K or azPEG5K) in methanol resulted in the modified particles exhibiting a similar photoluminescence relative to the PA/azICG particles. In addition, the quantum efficiency of the PEGylated PA/azICG particles was similar to the neat PA/azICG particles in methanol (cf. Table 1), suggesting that the attachment of the PEG chains did not influence the emission characteristics of the attached ICG.

Emission Enhancement with BSA Concentration

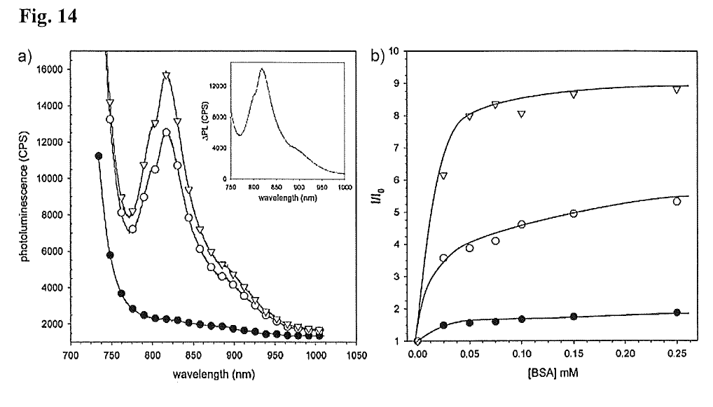

The utilization of an azICG-modified particle for any in vivo or in vitro imaging application will require the particles to be dispersed in an aqueous environment. The replacement of methanol for a PBS solution in the PA/azICG particles resulted in a total quenching of fluorescence. Due to the hydrophobic nature of the dye, the employment of PBS is speculated to have forced the bound azICG to sequester to the particle surface and dimerize.[20] Previous studies of free ICG in water indicated that physically bound ground state dimer formation occurred at low dye concentrations resulting in low fluorescence quantum yield of ca. 4×10⁻⁵ at an ICG concentration of ca. 2.7×10⁻³ mol·dm⁻³; this concentration of free dye would result in a theoretical inter-ICG distance of 80-90 Å. [20] In the current system, the attachment of the azICG to the surface of the particles results in the “local” concentration of chromophores to be significantly higher with an inter-azICG distance of 8-9 Å, promoting the dimerization in a poor solvent (cf. FIG. 12). The hydrophobic nature of the neat PA and PA/azICG particles was confirmed by contact angle measurements of films composed of the particles. The neat PA particles are relatively hydrophobic by the appearance of a contact angle of 73°, though with the grafting of azICG to their surface, the hydrophobicity of the particles is enhanced as indicated by the increase in contact angle to 87°. The surface of the particles was PEGylated in an attempt to enhance the hydrophicility of the particles and offer a way to separate the attached azICG. Though the attachment of the azPEG1K and azPEG5K chains to the particles did significantly reduce the contact angle of the particles to water to ca. 24° (cf. Table 1), there was no discernible photoluminescence of the particles in water or PBS. FIG. 14a presents the fluorescence of the PA/azICG/azPEG5K particles when dispersed in PBS, indicating an almost total quenching of fluorescence.

TABLE 1
Contact angle (θ) and quantum efficiency (φ) of surface
functionalized PA particles.

| | Contact angle (θ) | Quantum efficiency (φ) |
|---|---|---|
| Surface | Water | Methanol |
| PA | 73 ± 9 | — |
| PA/azICG | 87 ± 2 | 0.017 ± 0.004 |
| PA/azICG/azPEG_{1K} | 23 ± 3 | 0.015 ± 0.004 |
| PA/azICG/azPEG_{5K} | 25 ± 1 | 0.017 ± 0.004 |

In the current system, the PA/azICG/azPEG5K particles in PBS were mixed with bovine serum albumin (BSA) at various concentrations. With the addition of BSA to the solution, the observed fluorescence intensity of the modified particles increased dramatically. Serum albumin is a major protein constituent of blood plasma and this protein facilitates the disposition and transport of a variety of exogenous and endogenous ligands to specific regions. The delivery of ligands originates from two structurally selective binding sites where the binding affinity originates from a combination of hydrophobic, hydrogen bonding, and electrostatic interactions. The long term increase in emission output is presented in FIG. 14a for the addition of 0.025 and 0.25 mM BSA to the particles; these concentrations represent a ratio of 0.39 and 3.93 BSA molecules to every azICG in the system, respectively. The emission intensity in FIG. 14a exhibited an immediate increase within the first 30 min that accounted for ca. 25% of the total increase in intensity followed by a long term gradual increase. FIG. 14b presents the intensity ratio (I/Io) for the modified particles for various BSA concentrations after the systems have equilibrated for 4 days. The PA/azICG particles exhibit the least improvement in fluorescence emission with the addition of BSA, though with almost all BSA concentrations resulting in at least a 50% increase. The PA/azICG/azPEG1K particles exhibit a long term increase in intensity ratio of ca. 5 for the highest BSA concentration, although all concentrations of BSA resulted in significant emission enhancements, while the PA/azICG/azPEG5K particles, with the longer surface-attached PEG chains, offer the greatest improvement in emission intensity with the 4 day emission ratio being 8.5 for the majority of all BSA concentrations above 0.05×10⁻³M. At a BSA concentration of ca. 0.07×10⁻³ M, the number of BSA molecules is approximately equal to the total number of azICG in the system. The observed increase in fluorescence intensity with BSA binding likely results from the ability of the protein to “dissolve” hydrophobically aggregated azICG on the surface of the particles. The superior enhancement in emission intensity with longer PEG chains is speculated to be due to an entrapment process. As presented in the schematic of FIG. 12, it is assumed that the BSA proteins are continually absorbing and de-absorbing onto the particles at equilibrium, but as the PEG chains become longer, their extended length acts to retard the desorption through entanglement effects, thus forcing the proteins to spend more time near the surface of the particle and enhancing the time in which a protein is complexed with a surface tethered azICG.

This was confirmed by measuring the concentration of BSA entangled with the particles through the Bradford protein assay. For the particles employed in FIG. 14 with 0.1×10⁻³M BSA, the assay indicated that ˜233 BSA molecules were associated with every PA/azICG particle, while the PA/azICG/azPEG1K particles had 380 BSA molecules and the PA/azICG/azPEG5K-particles had 411 BSA molecules. On average, for every particle, there is a single BSA molecule for 130 azICG chromophores on the PA/azICG particles. This ratio is reduced for the PA/azICG/azPEG1K particles to 80 azICG/BSA, while for the PA/azICG/azPEG5K particles this ratio is 74.

Emission Enhancement with Time

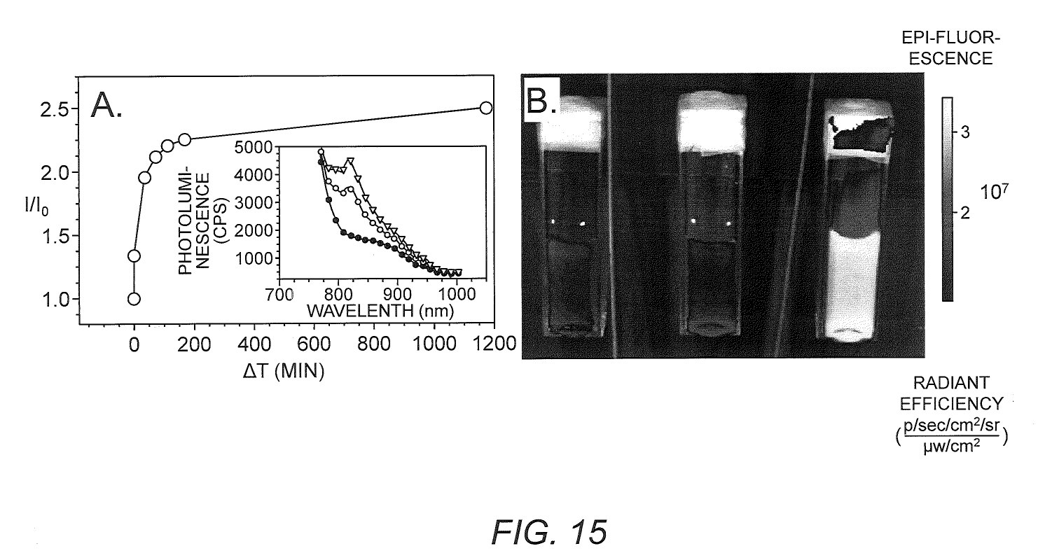

FIG. 15a presents the time evolution of the emission intensity ratio (I/Io measured at 819 nm) for the first 1200 min of PA/azICG/azPEG1K particles when dispersed in PBS and mixed with 0.014×10⁻³M BSA. In this system, the particles were mixed with BSA at a particle/protein 1:7 000 ratio (azICG/protein 1:0.22) and the photoluminescence spectrum (cf. FIG. 15a, inset) of the particles was measured every 30 min. There is an immediate increase in the emission intensity followed by a slower growth; the increase can be roughly modeled by an exponential rise to a maximum curve, which results in a time constant of ca. 15 min. For potential PDT applications, the PA/azICG/azPEG1K particles achieve 63% of their total 1 day emission increase within the first 15 min. FIG. 15b presents an optical micrograph of the PA/azICG/azPEG1K particles in water, PBS, and PBS after a 2 h exposure to 0.014×10⁻³ M BSA. These images demonstrate that (i) the quenched fluorescence of the modified particles in PBS can be “turned on” by the addition of BSA and (ii) even though the PA/azICG/azPEG1K particles do not exhibit as pronounced an emission increase relative to the PA/azICG/azPEG5K particles (cf. FIG. 14b), the increase in azICG emission is still clearly discernible. This latter feature facilitates the potential use of these particles in a combined in vivo luminescent imaging and PDT study of tumors.

In vitro Studies with Cancer Cells

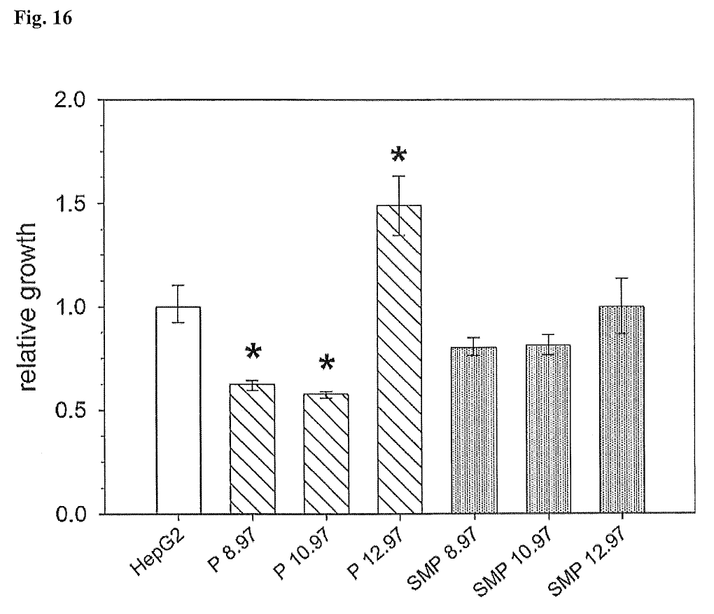

To assess the potential application of the PA/azICG/azPEG particles as photosensitizers for PDT and to determine whether the particles pose a toxic concern, cytotoxicity tests were carried out in HepG2 cancer cells; cell viability was determined via the 3-[4,5-dimethylthiazol-2-yl]-2,5-diphenyl tetrazolium, inner salt (MTS) assay. FIG. 16 presents the relative growth of the cells with both neat PA (blank) and PA/azICG/azPEG1K particles. At the lower particle concentrations, the blank nanoparticles (P) exhibited a statistically significant reduction in growth for the HepG2 cells, while there was statistically significant growth for the blank particles at the highest concentrations. The surface modified particles (SMP) reduced the growth of the HepG2 cells for all PA/azICG/azPEG1K particle concentrations, though the reduction was not significant. The all trans-conformer of the azPEG1K chain measures ca. 10 nm and its attachment to the particles should increase their diameter from approximately 70 to 90 nm. Due to the hydrophilic nature of PEG, the DLS determined diameter of the modified particles in water was >100 nm, larger than the predicted value. The large hydrodynamic size of the PA/azICG/azPEG1K particles relative to the neat PA particles may result in a less efficient cellular uptake at these concentrations.

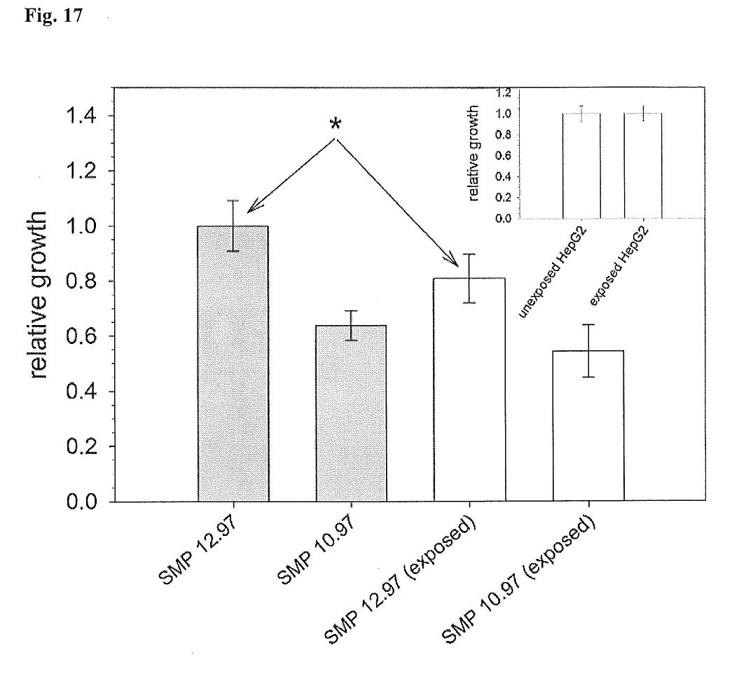

In addition, preliminary cell viability was studied with NIR light exposure following published procedures[47] to assess potential PDT performance. HepG2 cells secrete a variety of major plasma proteins; e.g., albumin,[48,49] which could enable the fluorescence of the PA/azICG/azPEG particles. The fluorescence is indicative of the electronic promotion from the ground singlet state to an excited singlet state with some excited singlets undergoing intersystem crossing to a longer-lived excited triplet state. Oxygen which is adjacent to the cells and modified particles may accept energy from the excited azICG chromophores and form the cytotoxic singlet oxygen, resulting in destruction of the cell. The preliminary PDT study performed with the PA/azICG/azPEG1K particles is presented in FIG. 17 and indicates a decrease in HepG2 cell growth after a 24 h incubation time post 15 min exposure to 780 nm light at a 0.04 mW·cm⁻² flux. Even for this relatively minor exposure, the cells exhibited a reduced growth with both particle densities. Without being limited to a particular theory, there appears to be an enhanced sensitivity to the higher concentration of particles, with the highest dose of particles resulting in a statistically significant reduction in growth (p<0.01); this would correlate to the higher number of azICG chromophores. To insure that exposure to the light alone did not result in the observed reduced growth, the inset in FIG. 17 presents the relative growth of the neat cells with and without light exposure, indicating no sensitivity to the radiation.

A general strategy for the preparation of particles with surface attached ICG, a near-infrared emitter, and PEG chains is described. PEGs of various molecular weights and ICG were modified with the addition of a terminal azide (azPEG and azICG) and then attached to PA colloids through a CuAAC performed in water. The placement of azICG onto the surface of the particles allowed for the chromophores to complex with proteins that resulted in the enhancement of the dye emission. In addition, the inclusion of azPEG with azICG onto the particle surface resulted in a synergistic enhancement of the fluorescence intensity, with azPEGs of increasing molecular weight amplifying the response. Preliminary PDT studies with HepG2 cells combined with particles surface-decorated with both azICG and azPEG indicated that a minor exposure to 780 nm radiation resulted in a statistically significant reduction in cell growth. These results suggest that the surface attachment of azide-modified ICG to particles and its availability to spatially adjacent molecular oxygen, coupled with protein enhanced fluorescence, may make these particles a valuable resource in the treatment of cancer.

### Experimental Section

### Reagents and Solvents

All the commercial reagents were purchased from Sigma-Aldrich and used without further purification. All the solvents were dried according to standard methods. Deionized water was obtained from a Thermo Scientific Barnstead NANOpureWater Purification System and exhibited a resistivity of ca. 10¹⁸·Ω⁻¹·cm⁻¹.

### Chemical Characterization Methods

¹H and ¹³C NMR spectra were recorded on a JEOL ECX300 spectrometer (300 MHz for proton and 76 MHz for carbon). Chemical shifts for protons are reported in parts per million downfield from tetramethylsilane and are referenced to residual protium in the NMR solvent (CDCl₃: δ 7.26 ppm, DMSO-d₆: δ 2.50 ppm). Chemical shifts for carbon is reported in parts per million downfield from tetramethylsilane and are referenced to the carbon resonances of the solvent (CDCl₃: δ 77.16). Electrospray ionization (ESI) mass spectra were obtained using the Finnigan LCQ classic spectrometer+HP 1 100 (HPLC). The IR spectra were recorded at room temperature in the wavenumber range of 400-4000 cm⁻¹ and referenced against air with a Nicolet 6700 FTIR instrument. A total of 32 scans were averaged for each sample at 2 cm⁻¹ resolution.

Preparation of Azide-Modified Indocyanine Green (azICG)

### 3-(3-Azidopropyl)-1,1,2-Trimethyl-1H-Benzo[e]Indolium Iodide (1)

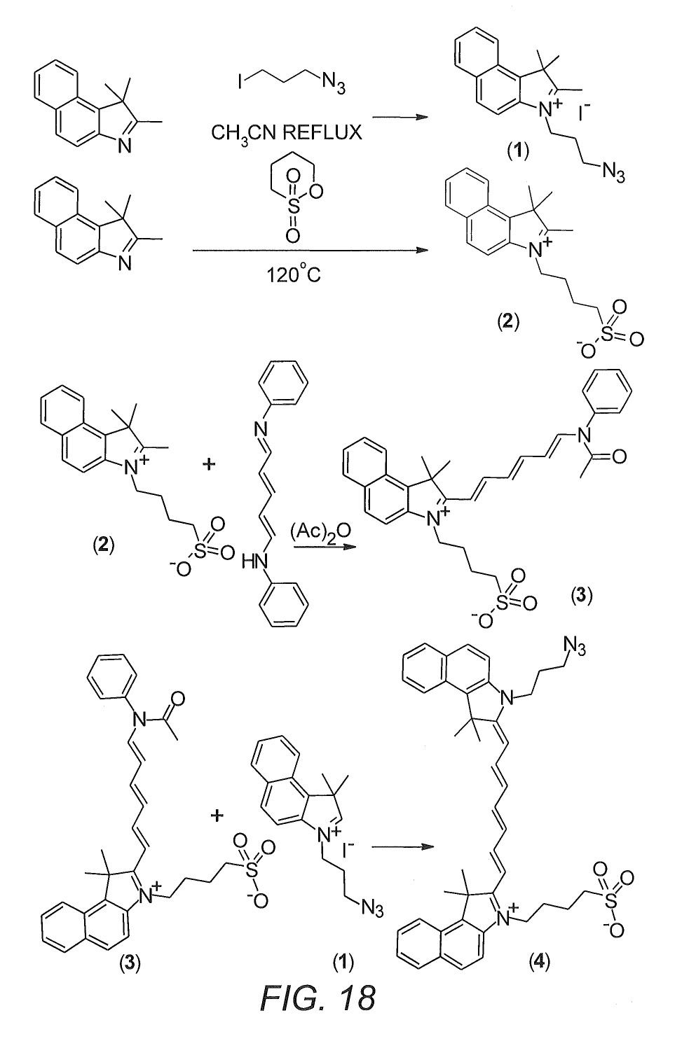

The solution of 2,3,3-trimethyl-4,5-benzo-3H-indole (1 g, 4.78 mmol) and 1-azido-3-iodopropane (2 g, 9.56 mmol) in acetonitrile (50 mL) was refluxed for 72 h. The solvent was evaporated under vacuum and the residue was dissolved in dichloromethane (10 mL). This solution was added dropwise to diethyl ether (80 mL) to precipitate a product (FIG. 18). This purification was done three times and the solid obtained was filtered and dried under vacuum (hygroscopic) to give a dark-brown product. Yield: 1.61 g (80%). ¹H NMR (CDCl₃), 1.87 (s, 6H), 2.37 (m, 2H, ³JHH=5.9 Hz, ³JHH=6.9 Hz), 3.25 (s, 3H), 3.76 (t, 2H, ³JHH=5.9 Hz), 5.00 (t, 2H, ³JHH=6.9 Hz), 7.70 (m, 3H, ³JHH=8.6 Hz, ⁴JHH=1.4 Hz, ⁴JHH=1.7 Hz), 7.96 (d, 1H, ³JHH=8.9 Hz), 8.10 (m, 2H, ³JHH=8.6 Hz, ³JHH=8.9 Hz). ¹³C NMR (CDCl₃) δ 16.9, 22.5, 27.4, 47.6, 48.8, 55.8, 112.7, 122.8, 127.5, 127.6, 128.5, 129.9, 131.4, 133.5, 136.8, 138.1, 196.0.

### 4-(1,1,2-Trimethyl-1H-Benzo[e]Indolium-3-yl)Butane-1-Sulfonate (2)

The solution of 2,3,3-trimethyl-4,5-benzo-3H-indole (0.6 g, 2.87 mmol) in 1,4-butane sultone (1.17 g, 8.59 mmol) was heated at 120° C. for 2 h. After cooling, the crystallized product was washed with acetone, filtered, and dried to give the compound (2) as a white solid. Yield: 0.92 g (93%). ¹H NMR ((CD₃)₂SO) 1.75 (s, 6H), 1.78 (m, 2H, ³JHH=7.2 Hz), 2.03 (m, 2H, ³JHH=7.6 Hz), 2.52 (t, 2H, ³JHH=7.2 Hz), 2.95 (s, 3H), 4.61 (t, 2H, ³JHH=7.6 Hz), 7.69-7.80 (m, 2H), 8.20 (d, 2H, ³JHH=8.9 Hz), 8.27 (d, 1H, ³JHH=8.9 Hz), 8.36 (d, 1H, ³JHH=7.9 Hz).

### 4-2-[(1E,3E,5E)-6-(Acetylanilino)-1,3,5-Hexatrienyl]-1,1-Dimethyl-1H-Benzo[e]Indolium-3-yl-1-Butanesulfonate (3)

The mixture of (2) (0.3 g, 0.88 mmol) and glutaconealdehyde dianil hydrochloride (0.27 g, 0.96 mmol) in acetic anhydride (4 mL) and acetic acid (1 mL) was heated at 110° C. for 2 h. After cooling, the solution was added dropwise to diethyl ether to precipitate a product. The solvent was decanted and the residue was dissolved in dichloromethane (3 mL) and precipitated from diethyl ether again. The solid was filtered, washed with water and dried under vacuum to give the product as a dark-purple solid. Yield: 0.36 g (76%). Melting point: 170° C. with a destruction. ¹H NMR ((CD₃)₂SO) 1.75 (m, 2H), 1.90 (m, 11H), 2.50 (t, 2H), 4.49 (t, 2H, ³JHH=7.9 Hz), 5.23 (d.d, 1H, ³JHH=11.7 Hz), 6.59 (d.d, 1H, ³JHH=11.0 Hz), 7.06 (d, 1H, ³JHH=15.1 Hz), 7.41 (d, 2H, 6.9 Hz), 7.60 (m, 4H), 7.76 (m, 2H), 8.15 (m, 5H), 8.38 (d, 1H, ³JHH=8.3 Hz).

### 4-(2-(1E,3E,5E,7E)-7-[3-(3-Azidopropyl)-1,1-Dimethyl-1,3-Dihydro-2H-Benzo[e]Indol-2-Ylidene]-1,3,5-Heptatrienyl-1,1-Dimethyl-1H-Benzo[e]Indolium-3-yl)-1-Butanesulfonate (azICG) (4)

The solution of (3) (1.7 g, 3.13 mmol) and (1) (1.44 g, 3.44 mmol) in the mixture of pyridine (20 mL), acetic acid (2 mL) and acetic anhydride (2 mL) was heated at 50° C. for 4 h. After cooling, this solution was added dropwise to diethyl ether to precipitate a crude product. This product was filtered and dried, dissolved in pyridine (4 mL) and quenched with diethyl ether once again. The solid obtained was filtered, washed with water and dried to give a dark green product. Yield: 2.1 g (96%, purity: 90%). ¹H NMR ((CD₃)₂SO) 1.91 (m, 18H), 2.5 (t, 2H), 3.54 (t, 2H, ³JHH=6.5 Hz), 4.22 (m, 4H), 6.34 (d, 1H, ³JHH=13.4 Hz), 6.59 (m, 3H), 7.50 (m, 2H), 7.66 (m, 3H), 7.80 (m, 2H), 7.90-8.10 (m, 6H), 8.25 (m, 2H). ESI-Mass (m/z; rel. intensity %): 700 (M+; 90), 564 (50), 408 (35), 346 (100). FTIR (cm⁻¹): 993, 1054 (s, ═C—H); 1350, 1399 (s, CH₂); 2089 (N₃).

Preparation of Azide-Modified Polyethylene Glycol (azPEG)

### Mono-Methoxy-PEG1000-Methansulfonate (6)

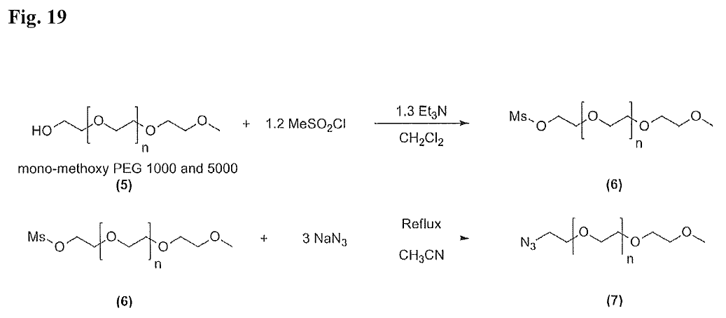

Triethylamine (0.39 g, 3.9 mmol) was added dropwise at room temperature to a stirred solution of mono-methoxy-PEG1000 (3 g, 3 mmol) and methylsulfonyl chloride (0.41 g, 3.6 mmol) in dichloromethane (30 mL). The solution was stirred at 20° C. for 4 h, then washed with water and the organic layer was dried with Na₂SO₄ with further filtration (FIG. 19). The solvent was evaporated under vacuum to give the product (6) as a white solid. Yield: 3 g (93%). ¹H NMR (CDCl₃) 3.07 (s, 3H), 3.36 (s, 3H), 3.53 (m, 2H), 3.62 (m, 78H), 3.74 (m, 2H), 4.36 (m, 2H).

### Mono-Methoxy-PEG1000-Azide (7)

The mixture of (6) (3 g, 2.78 mmol) and sodium azide (0.47 g, 7.23 mmol) in acetonitrile (30 mL) was refluxed and stirred for 6 h. After cooling, the mixture was filtered and the solvent was evaporated. The residue was dissolved in dichloromethane and washed with water, organic layer was separated, dried with Na₂SO₄ and filtered. The solvent was evaporated, the crystalline residue was washed with hexane, filtered, and dried in air to give the product as a white solid. Yield: 2.8 g (98%). ¹H NMR (CDCl₃) 3.37 (s, 3H), 3.39 (m, 2H), 3.55 (m, 2H), 3.64 (m, 80H). FTIR (cm⁻¹): 1 095 (s, C—O—C); 1340, 1465 (CH₂); 2 100 (N₃); 2 880 (s, CH₂).

A similar procedure was employed for the synthesis of monomethoxy-PEG5000-azide.

### Preparation of the Particles

Monodisperse cross-linked PA particles were prepared using an emulsion polymerization procedure. A standard emulsion apparatus was utilized where 0.05 g of sodium dodecyl sulfate (SDS, 99% Aldrich) was added to 75 mL of 18.2 MΩ water; this solution was allowed to stir at 250 rpm at 83° C. under a nitrogen purge. After a 60 min purge, 9 mL of the propargyl acrylate (PA) (98% Aldrich) and 1.8 mL of the divinyl benzene (DVB, 80% Aldrich) was added dropwise to the solution. The PA and the DVB were passed over alumina basic to remove inhibitors prior to being added to the solution. Once the addition of the PA/DVB mixture was completed, 0.393 mL of 3-alloxy-2-hydroxy-1 propanesulfonic acid sodium salt (COPS-1, 40 wt.-% soln. Aldrich) and 5 mL deionized water was added dropwise to the solution. After the COPS-1 was completely added, the solution was allowed to stir for an additional 5 min before 0.1 g potassium persulfate (KPS, 99+% Aldrich), which was mixed with 5 mL deionized water, was added to the solution. The emulsion polymerization was carried out under a nitrogen atmosphere for 40 min.

The resulting particles were dialyzed against deionized water for 2 weeks at 60° C. using a dialysis bag with a 50 000 MWCO and then shaken with an excess of mixed bed ion-exchange resin (Bio-Rad AG-501-X8(D)). After the cleaning procedure, the particle diameter was measured to be 73±7 nm (average and standard deviation), as indicated by a Coulter N4Plus dynamic light scattering (DLS) analyzer.

For a typical surface modification of the particles, for example, the grafting of azICG and azide-modified PEG chains with molecular weight of 1 000 (azPEG1K) onto the particles, 1 mL PA particles and 10.9 mg azICG were added to 2 mL of deionized water. Solutions of 0.07624 g copper(II) sulfate (99.999% Aldrich) in 10 mL deionized water and 0.3024 g sodium ascorbate (99% Aldrich) in 10 mL deionized water were made. Initially, 0.5 mL of the Cu(II)SO₄ solution was added to the PA/azICG solution, followed by 0.5 mL of the sodium ascorbate solution. The resulting mixture was maintained at a temperature of ca. 28° C. for 10 min and then the reaction was stopped by the removal of unreacted azICG, sodium ascorbate, and Cu(II)SO4 through a repeated particle washing procedure consisting of centrifugation and redispersement in methanol. The cleaned PA/azICG particles in water were subsequently utilized in a secondary click transformation with 39.12 mg azPEG1K, and previously presented Cu(II)SO4 and sodium ascorbate solutions. The reaction was allowed to run for 24 h and then washed to remove unreacted species as determined by photoluminescence measurements; these particles are referred to as PA/azICG/azPEG1K particles.

### Bradford Protein Assay

Protein determination per functionalized particle was determined using established procedures.[50] PA/azICG, PA/azICG/azPEG1K, and PA/azICG/azPEGSK particles incubated in the presence or absence of BSA (final 0.15×10⁻³ M) were collected by centrifugation at 15 000 g. After the supernatant was removed, the particles were washed with water. The supernatant and respective particles were incubated separately with the Bradfords reagent (Bio-Rad) for 10 min at 37° C. and the absorbance was measured at 595 nm using a spectrophotometer (Amersham Biosciences). The amount of BSA interacting with the particles was calculated using a BSA standard curve prepared with known BSA concentration standards.

### Cell Analysis

(Cell culture) HepG2 cells are a human hepatoma cell line and were obtained from ATCC (Rockville, Md.). All cells were cultured in phenol red-free Dulbeccos modified Eagles media (DMEM) containing 5% fetal bovine serum (FBS), 1% Penicillin-Streptomycin, and supplemented with glutamine (Invitrogen, Carlsbad, Calif.). Cells were cultured at 37° C. in a humidified atmosphere of 95% air/5% CO₂.

(Non-radioactive cell proliferation (MTS) assay) HepG2 cells were plated in 96 well plates at 20 000 cells per well, and exposed to 9.45×10⁸, 9.45×10¹⁰, and 9.45×10¹² particles·mL⁻¹ 24 h after initial plating. Proliferation was assayed colorimetrically 96 h after particle exposure with the Cell-Titer 96 Aqueous Non-Radioactive Cell Proliferation Assay (Promega, Madison, Wis.). Briefly, medium was decanted and a solution containing 100 mL 10% FBS with DMEM media and 20 mL 3-(4,5-dimethylthiazol-2-yl)-5-(3-carboxymethoxyphenyl)-2-(4-sulfophenyl)-2H-tetrazolium, inner salt (MTS) and phenazine methosulfate (PMS) was added to each well. After 60 min, the wells were scanned colorimetrically at 490 nm on a VersaMax spectrophotometer (Molecular Devices, Sunnyvale, Calif.). The conversion of MTS into an aqueous soluble formazan product is achieved only by dehydrogenase enzymes which are present in metabolically active cells; the absorbance at 490 nm from the formazan product is directly proportional to the number of living cells in culture.

### Optical Characterization Methods

Absorption spectra were taken using a Perkin-Elmer Lambda 900 UV/VIS/NIR spectrophotometer. Photoluminescence (PL) spectra were collected using a Thermo Oriel xenon arc lamp (Thermo Oriel 66 902) mated with a Thermo Oriel Cornerstone 7 400 1/8m monochromator (Thermo Oriel 7400) and a Horiba Jobin-Yvon MicroHR spectrometer coupled to a Synapse CCD detector. Quantum yields (φ) of the dyes and modified particles were determined relative to the reference dye 1,10,3,3,30,30-hexamethylindotricarbocyanine iodide (HITCI) in methanol, which has a fluorescence quantum yield of φ_{ref}=0.12, [51,20] employing established procedures. [52]

### REFERENCES

[1] A. K. Gupta, M. Gupta, Biomaterials 2005, 26, 3995.
[2] A. H. Lu, E. L. Salabas, F. Schuth, Angew. Chem., Int. Ed. 2007, 46, 1222.
[3] C. Medina, M. J. Santos-Martinez, A. Radomski, 0.1. Corrigan, M. W. Radomski, Br. J. Pharmacol. 2007, 150, 552.
[4] W. H. De Jong, P. J. A. Borm, Int. J. Nanomed. 2008, 3, 133.
[5] V. P. Torchilin, Adv. Drug Delivery Rev. 2006, 58, 1532.
[6] S. B. Brown, E. A. Brown, I. Walker, Lancet Oncol. 2004, 5, 497.
[7] Z. Huang, Technol. Cancer Res. Treatment 2005, 4, 283.
[8] T. J. Dougherty, C. J. Gomer, B. W. Henderson, G. Joni, D. Kessel, M. Korbelik, J. Moan, Q. Peng, J. Natl. Cancer Inst. 1998, 90, 889.
[9] J. Malicka, I. Gryczynski, C. D. Geddes, J. R. Lakowicz, J. Biomed. Opt. 2003, 8, 472.
[10] J. V. Frangioni, Curr. Opin. Chem. Biol. 2003, 7, 626.
[11] T. W. Olsen, J. I. Lim, A. Capone, R. A. Myles, J. P. Gilman, Arch. Ophthalmol. 1996, 114, 97.
[12] R. C. Benson, H. A. Kues, Phys. Med. Biol. 1978, 23, 159.
[13] K. Motomura, H. Inaji, Y. Komoike, T. Kasugai, S, Noguchi, H. Koyama, Jpn. J. Clin. Oncol. 1999, 29, 604.
[14] H. Ishihara, H. Okawa, T. Iwakawa, N. Umegaki, T. Tsubo, A. Matsuki, Anesth. Analg. 2002, 94, 781.
[15] P. Ott, Pharmacol. Toxicol. 1998, 83, 7.
[16] G. Paumgart, P. Probst, R. Kraines, C. M. Leevy, Ann. NY Acad. Sci. 1970, 170, 134.
[17] S. Reindl, A. Penzkofer, S. H. Gong, M. Landthaler, R. M. Szeimies, C. Abels, W. Baumler, J. Photochem. Photobiol. AChem. 1997, 105, 65.
[18] W. Baumler, C. Abels, S. Karrer, T. Weiss, H. Messmann, M. Landthaler, R. M. Szeimies, Br. J. Cancer 1999, 80, 360.
[19] T. Desmettre, J. M. Devoisselle, S. Mordon, Surv. Ophthalmol. 2000, 45, 15.
[20] R. Philip, A. Penzkofer, W. Baumler, R. M. Szeimies, C. Abels, J. Photochem. Photobiol. A-Chem. 1996, 96, 137.
[21] S. A. Soper, Q. L. Mattingly, J. Am. Chem. Soc. 1994, 116, 3744.
[22] R. Simmons, R. J. Shephard, J. Appl. Physiol. 1971, 30, 502.
[23] J. Gathje, R. R. Steuer, K. R. Nicholes, J. Appl. Physiol. 1970, 29, 181.
[24] T. J. Muckle, Biochem. Med. 1976, 15, 17.
[25] P. Sharma, S. Brown, G. Walter, S. Santra, B. Moudgil, Adv. Colloid Interface Sci. 2006, 123, 471.
[26] S. Jin, K. M. Ye, Biotechnol. Prog. 2007, 23, 32.
[27] J. Yu, M. A. Yaseen, B. Anvari, M. S. Wong, Chem. Mater. 2007, 19, 1277.
[28] E. I. Altinoglu, T. J. Russin, J. M. Kaiser, B. M. Barth, P. C. Eklund, M. Kester, J. H. Adair, ACS Nano 2008, 2, 2075.
[29] V. Saxena, M. Sadoqi, J. Shao, J. Photochem, Photobiol. B-Biol. 2004, 74, 29.
[30] V. B. Rodriguez, S. M. Henry, A. S. Hoffman, P. S. Stayton, X. D. Li, S. H. Pun, J. Biomed. Opt, 2008, 13, 014025.
[31] G. Kim, S. W. Huang, K. C. Day, M. O'Donnell, R. R. Agayan, M. A. Day, R. Kopelman, S. Ashkenazi, J. Biomed. Opt. 2007, 12, 044020.
[32] A. C. Bhasikuttan, J. Mohanty, W. M. Nau, H. Pal, Angew. Chem., Int. Ed. 2007, 46, 4120.
[33] R. Zadmard, T. Schrader, J. Am. Chem. Soc. 2005, 127, 904.
[34] J. R. Babendure, S. R. Adams, R. Y. Tsien, J. Am. Chem. Soc. 2003, 125, 14716.
[35] V. S. Jisha, K. T. Arun, M. Hariharan, D. Ramaiah, J. Phys. Chem. B 2010, 114, 5912.
[36] V. S. Jisha, K. T. Arun, M. Hariharan, D. Ramaiah, J. Am. Chem. Soc. 2006, 128, 6024.
[37] S. Fickweiler, R. M. Szeimies, W. Baumler, P. Steinbach, S. Karrer, A. E. Goetz, C. Abels, F. Hofstadter, M. Landthaler, J. Photochem. Photobiol. B-Biol. 1997, 38, 178.
[38] M. L. J. Landsman, G. Kwant, G. A. Mook, W. G. Zijlstra, J. Appl. Physiol. 1976, 40, 575.
[39] F. Rotermund, R. Weigand, A. Penzkofer, Chem. Phys. 1997, 220, 385.
[40] R. Weigand, F. Rotermund, A. Penzkofer, Chem. Phys. 1997, 220, 373.
[41] A. K. Kirchherr, A. Briel, K. Mader, Mol. Pharm. 2009, 6, 480.
[42] E. Mubarekyan, M. Santore, Langmuir 1998, 14, 1597.
[43] T. J. Russin, E. I. Altinoglu, J. H. Adair, P. C. Eklund, J. Phys.: Condens. Matter 2010, 22, 334217.
[44] J. N. Ketley, W. H. Habig, W. B. Jakoby, J. Biol. Chem. 1975, 250, 8670.
[45] K. Sauda, T. Imasaka, N. Ishibashi, Anal. Chem. 1986, 58, 2649.
[46] T. Imasaka, T. Okazaki, N. Ishibashi, Anal, Chim. Acta 1988, 208, 325.
[47] O. Bozkulak, R. F. Yamaci, O. Tabakoglu, M. Gulsoy, Photodiag. Photodyn. Ther. 2009, 6, 117.
[48] B. B. Knowles, C. C. Howe, D. P. Aden, Science 1980, 209, 497.
[49] X. H. Zhu, C. H. Wang, Y. W. Tong, J. Biomed. Mater. Res. Part B Appl. Biomater. 2007, 82B, 7.
[50] M. M. Bradford, Anal. Biochem. 1976, 72, 248.
[51] P. Sperber, W. Spangler, B. Meier, A. Penzkofer, Opt. Quantum Electron. 1988, 20, 395.
[52] A. T. R. Williams, S. A. Winfield, J. N. Miller, Analyst 1983, 108, 1067.

The foregoing is illustrative of the present invention, and is not to be construed as limiting thereof. The invention is defined by the following claims, with equivalents of the claims to be included therein. All publications, patent applications, patents, patent publications, sequences identified by GenBank and/or SNP accession numbers, and other references cited herein are incorporated by reference in their entireties for the teachings relevant to the sentence and/or paragraph in which the reference is presented.

That which is claimed is:

1. A method of producing a substrate modified colloidal particle comprising,
providing a suspension of colloidal particles in an aqueous solution, wherein the colloidal particles comprise a polymer core and a surface of the polymer core comprises a click chemistry functional group;
adding a substrate to the suspension; and
attaching the substrate to the colloidal particle using a click chemistry reaction.

2. The method of claim 1, wherein the polymer core comprises a polymer is selected from the group consisting of poly(propargyl acrylate), polymethacrylate, poly(methyl-methacrylate), polystyrene, poly(propargyl acrylate-co-methacryalte), poly(propargyl acrylate-co-methyl-methacrylate), poly(propargyl acrylate-co-styrene), and any combination thereof.

3. The method of claim 1, wherein the suspension of colloidal particles of said providing step is monodisperse.

4. The method of claim 1, wherein the colloidal particles of said providing step are each about 50 to about 110 nm in diameter.

5. The method of claim 1, wherein the colloidal particles are crosslinked.

6. The method of claim 1, wherein the click chemistry reaction is carried out at a temperature of about 15° C. to about 35° C.

7. The method of claim 1, wherein the click chemistry reaction is carried out for a period of time of about 1 minute to about 4 days.

8. The method of claim 1, wherein the substrate is attached to the colloidal particle with a grafting density of about 1 to about 5 substrate/nm².

9. A colloidal particle comprising a polymer core and a substrate attached to an outer surface of the polymer core, wherein upon contact with a target molecule having an affinity for the substrate, the colloidal particle immobilizes the target molecule and subsequently releases the target molecule, and wherein the released target molecule has a bioactivity similar to the bioactivity of the target molecule prior to immobilization with the colloidal particle.

10. The colloidal particle of claim 9, wherein the polymer core comprises a polymer selected from the group consisting of poly(propargyl acrylate), polymethacrylate, poly(methyl-methacrylate), polystyrene, poly(propargyl acrylate-co-methacryalte), poly(propargyl acrylate-co-methyl-methacrylate), poly(propargyl acrylate-co-styrene), and any combination thereof.

11. The colloidal particle of claim 9, wherein the substrate is selected from the group consisting of a peptide, a protein, an enzyme substrate, a ligand, DNA, RNA, an organic compound, an inorganic compound, a polymer, a fluorescent compound, one half of a binding pair, and combinations thereof.

12. The colloidal particle of claim 9, wherein the target molecule is a protein and is selected from the group consisting of an enzyme, a transcription factor, a carrier protein, a membrane protein, a signal transduction protein, and combinations thereof.

13. A method for isolating a target molecule from a mixture comprising:
providing the colloidal particle of claim 9;
adding the colloidal particle to a mixture comprising the target molecule;
incubating the colloidal particle with the mixture for a period of time wherein the colloidal particle attaches to the target molecule; and
removing the colloidal particle attached to the target molecule from the mixture, thereby isolating the target molecule from the mixture.

14. The method of claim 13, further comprising releasing the target molecule from the colloidal particle to provide the isolated target molecule, wherein the isolated target molecule has a bioactivity similar to its bioactivity prior to binding the colloidal particle.

15. A colloidal particle comprising a polymer core and a fluorescent substrate attached to an outer surface of the polymer core, wherein the emission and/or intensity of the fluorescent substrate is increased compared to the emission and/or intensity of an unbound fluorescent substrate.

16. The colloidal particle of claim 15, wherein the polymer core comprises a polymer selected from the group consisting of poly(propargyl acrylate), polymethacrylate, poly(methyl-methacrylate), polystyrene, poly(propargyl acrylate-co-methacryalte), poly(propargyl acrylate-co-methyl-methacrylate), poly(propargyl acrylate-co-styrene), and any combination thereof.

17. The colloidal particle of any of claim 15, wherein the fluorescent substrate is a near-infrared emitter.

18. A method of inhibiting proliferation of a cell in a subject comprising:
administering to a subject the colloidal particle of claim 15; and
exposing the subject to radiation, thereby inhibiting proliferation of a cell in the subject.

19. The method of claim 18, wherein the colloidal particle further comprises a polymer substrate attached to an outer surface of the colloidal particle.

20. The method of claim 18, further comprising contacting the colloidal particle to a biomolecule prior to exposing the subject to radiation.
